(19) United States
(12) Patent Application Publication
(10) Pub. No.: US 2015/0149666 A1
(43) Pub. Date: May 28, 2015

(54) Event System and Methods for Using Same

(71) Applicant: Mcorelab, Inc., Sparks, NV (US)

(72) Inventors: Yilin Wang, Sparks, NV (US); Zheng Liu, Sparks, NV (US)

(73) Assignee: MCORELAB, INC., Sparks, NV (US)

(21) Appl. No.: 14/609,175

(22) Filed: Jan. 29, 2015

Related U.S. Application Data
(63) Continuation of application No. 13/556,057, filed on Jul. 23, 2012, now abandoned.
(60) Provisional application No. 61/510,994, filed on Jul. 22, 2011.
(60) Provisional application No. 61/674,645, filed on Jul. 23, 2012.

(51) Int. Cl. G06F 13/22

(52) U.S. Cl. CPC G06F 13/22
USPC 710/46

(57) ABSTRACT

Event systems and methods are provided through which applications can manage input/output operations (“I/O”) and inter-processor communications. An event system in conjunction with fast I/O is operable to discover, handle and distribute events. The system and method disclosed can be applied to combinations that include event-driven models and event-polling models. In some embodiments, I/O sources and application sources direct events and messages to the same destination queue. In some embodiments, the system and methods include configurable event distribution and event filtering mechanisms operable to effect and direct event distribution for multiple event types using multiple methods. In some embodiments, the system disclosed includes enhanced event handler API's. Some embodiments include a multicast API operable to allow applications to perform multicasting in a single API call. In addition, various mechanisms of the disclosed event system can be combined with traditional operating systems.

### CROSS-REFERENCE TO RELATED APPLICATIONS

The present application is a continuation of the applicants' U.S. non-provisional patent application Ser. No. 13/556,057, entitled “Event Systems and Method for Using Same,” filed on Jul. 23, 2012, which claims priority through, and the present application claim priority through, the applicants' prior provisional patent applications, entitled:
1. Event Systems and Input/Output Systems, Ser. No. 61/510,994, filed Jul. 22, 2011; and
2. Event System And Methods For Using Same, Ser. No. 64/674,645, filed Jul. 23, 2012.
   All such non-provisional and provisional applications are hereby incorporated by reference in their entirety.

### FIELD OF TECHNOLOGY

The present invention relates generally to computer systems, and more particularly, to event systems through which applications can manage input/output operations (“I/O”) and inter-processor communications.

### BACKGROUND

I/O and event services are important elements of every computer system. Traditionally, these services were provided by the operating system (“OS”) to applications. Input and output (“I/O”) operations included, for example, sending and receiving messages to and from the network, reading and writing files to disks, and reading and writing to network attached storage. In addition to the basic I/O operation calls such as send( ), recv( ), read( ), and write( ), operating systems often provided applications with additional methods for the processing of events in an attempt to facilitate the processing of multiple I/O event streams. For example, operating systems implemented functions such as select( ) poll( ), epoll( ), and I/O completion ports, which facilitated the processing events from multiple file descriptors, such as multiple sockets or multiple file operations or combination of sockets and file operations. File descriptors are abstract indicators (e.g. a number) that represent access to a file or to I/O. A file descriptor of a socket, for example, represents access to a network. Similarly, a file descriptor can represent access to a block device such as disk or access to a file. As another example, operating system facilities such as asynchronous I/O provided a way for applications to perform other operations while waiting for prior posted I/O operations to complete. All these mechanisms and systems that facilitated the processing of multiple I/O event streams were collectively referred to as an event system.

Today's I/O event systems can be grouped into two categories: 1) traditional operating system event systems; and 2) operating system kernel-bypassing network systems.

Conventional computer operating systems generally segregate virtual memory into kernel-space and user-space. Kernel-space is a privileged space reserved for running the kernel, kernel extensions, and where most device drivers run in today's operating systems. In contrast, user-space is the memory area where all user mode applications work.

One problem with traditional event systems is that such systems performed slowly. Traditional operating system I/O and event systems were implemented in kernel-space. When applications needed to access system resources (e.g. files, disks, and Network Interface Controller (“NIC”)), applications used system calls, which went through context switching when accessing kernel space. In addition, when events arrived from I/O devices such as NICs or disks, traditional operating system's I/O and event system architectures used interrupt-based methods as the primary I/O event discovery mechanisms. Interrupts interrupt the CPU processor and context-switch out whatever program was running on the interrupted CPU processor in order to handle the interrupts. Context-switching would sometimes also occur in the event delivery paths of the traditional operating system's event system. The traditional operating system I/O and event system architecture incurred significant overhead associated with interrupt and context-switching.

The operating system kernel-bypassing network system solutions offered faster I/O that reduced the interrupt and context-switching overheads. However, these kernel-bypassing network systems were lacking in event system offerings. The only type of event processing model that the existing operating system kernel-bypassing network systems offered was the application polling model, lacking alternative event processing models. Further, the architecture and implementation of the application polling model offered by these systems lacked scalability.

One type of application polling API offered by conventional systems was the select( ) and poll( ) mechanism, which took multiple file descriptors and polled for events on the multiple file descriptors. Other types of application polling API's offered by conventional systems included epoll( ) and I/O completion port. In these API's, applications registered interest on events of file descriptors by calling API's such as epoll_ctl( ), and then made system calls, such as epoll_wait( ), to poll for events. Regardless of which API's are implemented, it is the architecture underlying the API's that determines the scalability and performance of the system.

In existing operating system kernel-bypassing network systems, as well as in traditional operating system kernel's implementation of select( ) and poll( ), the system polled each of the file descriptor objects. These polling mechanisms lacked scalability when applications monitored large numbers of descriptors. With the emergence of web applications serving huge numbers of users simultaneously and having thousands of open connections, each represented by an open socket, these scalability limitations became particularly significant. In this type of polling model, the polling mechanism would poll each of the thousands of sockets, resulting in the number of polling operation increasing linearly with the number of descriptors, thus impacting the ability for such systems to service a growing user base.

In other existing architectures, in particular, in traditional operating system kernel's implementation of epoll( ) and I/O completion port, kernel queues were used, and thus avoided the above noted scalability problem specifically related to the handling of many file descriptors. However, the traditional operating system I/O and event system architectures, including kernel queue implementation, bounded the performance of such systems, as they incurred significant overhead due to the high levels of context-switching and interrupts, as well as due to the additional user-kernel communication involved.

These existing event polling architectures, having either scalability limitations or performance problems or both, resulted in applications having to choose between implementing a solution with faster network I/O but no scalability, or alternatively, implementing a solution within a traditional operating system that exhibited poor performance. A system that avoided both limitations in a single solution was needed.

In an effort to increase network performance, kernel-bypass network stacks were developed. These methods and systems bypassed the operating system kernel and interfaced with the underlying NIC. User-space applications and libraries were afforded direct access to what were known as virtual interfaces. A virtual interface allowed a user-space application or library to access an I/O provider (e.g. the NIC) and perform data transfers through memory that an application (or user-space library) registered with the NIC and that the NIC can also access. Most of today's high performance NICs, including Infiniband and 10G Ethernet NICs, are based on the virtual interface architecture (“VIA”). In so doing, these systems offered applications faster access to the underlying I/O hardware as compared to going through the operating system kernel.

While these existing operating system kernel-bypass systems reduced network messaging latency, they were merely libraries on top of the NIC I/O provider. As such, these architectures did not offer comprehensive event systems like those included in traditional operating systems. Socket libraries were implemented on top of each vendor's NIC implementation of the virtual interface, and the event system consisted of no more than a translation of application calls to select( ), poll( ), and epoll( ) into polling operations on the list of sockets. For example, even though epoll( ) was implemented in these conventional kernel-bypass approaches, the epoll( ) override was nothing more than a polling of the list of file descriptors that were pre-registered through a call to epoll_ctl( ). This being the case, each file descriptor that an application was interested in had to be polled. As the number of sockets monitored by an application increased, the number of polling operation increased linearly with the number of sockets. As a result, these systems, like the file descriptor polling architecture discussed previously, lacked scalability.

Another form of I/O and event polling in conventional systems was asynchronous I/O. Asynchronous I/O is a form of input/output processing that permits other processing to continue before the transmission has finished. When an application called an asynchronous version of I/O operations, such as asynchronous versions of read( ), write( ), send( ), and recv( ), the individual I/O operation was posted to the system. The asynchronous API then returned to the application, but did so without including the results of the I/O operation. The application proceeded to perform other operations while waiting for the posted I/O operation to complete. Upon completion of the posted I/O operation, events were generated and an application would then poll for the completion events. This model was referred to as a post-and-completion model, a completion model, or an asynchronous I/O model. One disadvantage of this approach was that applications had to perform prior posting of I/O operations before IO events could be delivered, which both increased the number of system calls applications were required to make, as well as increased the system processing overhead such as binding at each I/O operation posting.

Further, these existing event systems had mechanisms that were disparate and completely separated from inter-process or inter-thread communication mechanisms. For example, in existing systems, applications had to include one type of programming to process I/O events, and another type of programming to effect communications among application threads or processes. Neither the traditional operating system event systems, nor the kernel-bypass network systems, offered applications a way to scale event processing across multiple processing cores. For example, in the existing event mechanisms, there is a lack of effective event distribution mechanisms, and no mechanism for applications to specify distribution of events to particular processors.

In addition to the above drawbacks with these prior solutions, there were other deficiencies with traditional I/O processing. For example, there was a lack of an efficient and flexible multicast interface. Multicasting mechanisms enable sending the same message or pay-load to multiple destinations in a single I/O operation. Performing multicasting using conventional mechanisms involved significant setup and administrative overhead. For example, multicast groups had to be statically formed prior to the multicast operation, where the multicast group was given an IP address as the multicast address. Applications would then perform multicasting by sending the message to the multicast address. This meant that applications had to incur the administrative overhead involved with a multi-step process involved in setting up static groups prior to performing send operations. The only method available for avoiding this administrative overhead was for applications to use individual I/O operations to send the message to each destination. This alternative solution incurred large system call overhead due to the quantity of system calls. Again, applications are left having to select between two undesirable drawbacks, in this case, either sacrificing flexibility and incurring administrative overhead, or alternatively, sacrificing performance by making an excessive number of system calls.

### SUMMARY

It is to be understood that this Summary recites some aspects of the present disclosure, but there are other novel and advantageous aspects. They will become apparent as this specification proceeds.

Briefly and in general terms, the present invention provides for event systems that support both integration with fast I/O, and feature-specific integration with traditional operating systems.

In some embodiments, new methods and a new framework for implementing a full event system is implemented in conjunction with fast I/O. Fast I/O event polling and discovery mechanisms eliminate the interrupt and context-switching overhead associated with traditional operating system I/O and event systems.

Some embodiments of the event system implement event-driven processing models on top of the fast I/O event polling and discovery mechanisms, offering new and high performance ways of event processing not available in existing kernel-bypass network or traditional operating systems.

In some embodiments, the system actively and continuously polls I/O devices by running I/O event polling and servicing threads on dedicated processors. Upon event discovery by the I/O event polling threads, the event system invokes application event handlers in various ways. The structure of some of these embodiments obtains one or more of the following advantages:
1) The active polling methods combined with invocation of application event handlers by the event system provides for timely discovery of I/O events without interrupt and context-switching overhead, as well as timely event processing by application event handlers. Together, this combination provides event processing efficiency and high performance.
2) The event system invokes the event handler upon event delivery, and does not poll each file descriptor I/O object. This results in a scalable event system across an increasing number of file descriptors.
3) Dedication of processors to the I/O event polling threads allow these threads to run for extended periods of time and generate streams of I/O events with a reduction in interference from the operating system kernel scheduler as compared to using a regular thread, thus further improving performance.
4) Combining this mechanism with the event system calling the application event handler, in contrast to waiting for the application to poll, offers improved CPU cache locality and utilization, particularly on multi-core processors.
5) Dedication of processors further provides benefits in combination with concurrent and parallel processing, which will become apparent as this specification proceeds.

In some embodiments, events discovered by the system I/O polling threads are queued to a shared memory queues of the event system, which are subsequently polled by other event system threads executing in the application address-space. Upon retrieval of events from the shared memory queues, these other event system threads in the application address-space subsequently call the application event handlers. When combined with the dedication of processors, these other event system threads that run in application-address space are referred to as application processors. Some implementations of these embodiments achieve one or more of the following substantial advantages:
1) Since the application processors that invoke the event handlers run in the application address-space, the application event handlers automatically have access to all application memory without context switching. In some embodiments, enqueuing and dequeuing of the events is accomplished through shared memory, and the entire event system paths are without context switching, thus improving overall performance.
2) When combined with the dedication of processors and parallel processing, the application concurrently processes the events on a separate processor from the system I/O polling thread processor. When further combined with the use of a plurality of such application processors and the event distribution facilities also disclosed in this application, the event streams generated by the fast I/O event discovery mechanisms can be distributed to multiple application processors for concurrent processing in parallel.

In some embodiments, application event handlers are directly called from the event system I/O polling threads. This allows some of these embodiments to obtain one or more of the following advantages:
1) Multiple system I/O polling threads can be executed concurrently. For example, each system I/O polling thread polls different I/O ports or devices, with each of these system I/O polling threads calling application event handlers, resulting in parallel I/O event processing. In some embodiments, each of the multiple system I/O polling threads run on dedicated processors, offering further efficiency for parallel I/O event processing.
2) In some of these embodiments, enhancements to event handler invocation methods are also provided such that event handlers directly invoked by the event system I/O polling threads, which may execute in a different address-space from the application address-space, can have access to application memory.

Some of the embodiments of the event-driven methods include a novel event handler API. The structure and functionality of this API can be implemented to achieve one or more of the following advantages:
1) The application event handler API includes a parameter for passing the I/O object (e.g. socket) receiving the events. The parameter is given in indirect reference form, such as an opaque handle or descriptor. This presents a higher-level view to applications and avoids demultiplexing, protocol processing, or both by application handlers. This also facilitates a protection boundary between the system and the application, and among multiple applications. Further, this allows internal system structures to be modified independent of applications. In some embodiments, the event handler API is extended beyond network I/O to other forms of I/O and non-I/O events.
2) All necessary information for event processing is passed through the parameters of the event handler API when the system invokes the application handler. This removes the need for additional calls to individual I/O operations such as recv( ) or accept( ) in order to process events, substantially reducing the number of system calls needed for applications to process events.

Some embodiments of the event system implement scalable event polling processing models on top of the fast I/O event polling and discovery mechanisms. These facilities address both the scalability and performance limitations found in existing systems by removing the polling of each file descriptor, and by eliminating interrupt and context-switching overheads.

In some embodiments, the system employs an event queue that stores events from multiple file descriptor objects in conjunction with fast I/O event discovery mechanisms. I/O events discovered from fast I/O polling mechanisms are delivered to the event queue as events arrive. Application then poll for events from these event queues. The central action of event polling then is the dequeuing of events from the event queue, which can collect events of any number of descriptors. Combining these mechanism as described allows some of these embodiments to obtain the following advantages:
1) I/O event discovery systems use fast I/O event polling mechanisms, eliminating the interrupt and context switching associated with traditional operating system I/O architectures, thus achieving high performance. In addition, in some embodiments, the event delivery that includes enqueuing and dequeuing of events to and from the event queue use shared-memory, thus further eliminating context switching.
2) As there is no polling of each file descriptor, application polling for events is scalable irrespective of the number of file descriptors.
3) Events are delivered to the event queues as events arrive, without requiring application prior posting of individual asynchronous I/O operations. Applications configure event delivery to event queues at a higher level than individual asynchronous I/O operations, for example, binding events of a descriptor or set of descriptors to event queues, or type of events to event queues. Once configured, events are delivered as they are discovered by the fast I/O event discovery mechanisms. This offers improved response time in terms of event delivery and eliminates the overhead associated with the posting of asynchronous I/O on each I/O event in the prior post-and-completion designs.
4) Elimination of the interrupt and context switching associated with traditional operating system I/O architecture, thus achieving improved performance.

Some embodiments of the event system implement event queuing mechanisms that allow applications to enqueue application-specific events to the same event system capable of receiving I/O events, thus providing a unified system for applications to efficiently handle I/O events, and inter-processor communication and inter-process communication. In some embodiments, the event system includes methods for applications to enqueue application-specific events or messages to the same event queue where I/O events are delivered. The event queue is capable of storing I/O events from multiple file descriptor objects, as fast I/O event polling mechanisms discover the I/O events and enqueue them onto the event queue. The same queue also supports enqueuing of application-specific events or messages, thus forming a dual-use queue. The same event system can be used by applications for inter-process or inter-processor communication, as well as for I/O events. Applications can enqueue and dequeue arbitrary application specific objects, and thus use the event queues for general-purpose, inter-process or inter-processor communication. As a result, for some embodiments offering these facilities, applications can use the same set of methods and mechanisms to handle both I/O, and inter-process or inter-processor communication events.

Some embodiments of the event system include event distribution mechanisms implemented in conjunction with event-driven and event polling models of event processing, further increasing the scalability of the event system on multi-core and multi-processor systems. In some of these embodiments, scalable event systems with event queues capable of enqueuing and dequeuing I/O events associated with multiple file descriptors are combined with event distribution mechanisms where I/O events are distributed to multiple of such event queues. These queues are, in turn, polled by multiple processing cores, thus providing scalable parallel processing of events concurrently from multiple processors.

In some of these embodiments implementing the event distribution system, applications configure event distribution to particular processors or queues through system-provided APIs, thus allowing application-level control of the event distribution and the processing cores to be used for parallel processing. Once configured, incoming events are then distributed to multiple destinations without the need for application prior posting of individual asynchronous I/O operations. This offers improved system efficiency as well as improved response time for event delivery.

Some embodiments implement event distribution methods in conjunction with event systems. These methods enable the directing of events to destinations based on round-robin methods, augmented round-robin methods, the consulting of load information, cache-affinity, flow-affinity, user-defined rules or filters, or some combination thereof. These methods distribute events in a concurrent environment where multiple processors act in parallel, thus providing for the scaling of event processing, something not available in existing event systems.

Some embodiments combine the event-driven model of event processing with event queuing mechanisms that allow applications to enqueue application-specific events. Upon discovery of events by, for example, a fast I/O event polling mechanism, application event handlers are called by the event system. Within these application event handlers, the application can call event queuing functions provided by the event system, and thus send inter-processor or inter-process communication to effect further processing. Similarly, within the application event handlers, the application can call light-weight task enqueue functions to enqueue tasks onto processors for further processing. Light-weight task enqueue and dequeue methods using shared memory and without context-switching are also provided by this system.

Some embodiments include a new multicast API that allows applications to perform multicasting in a single API call. This call includes parameters that specify multiple destinations for the multicast, and includes the message to send. The same message is then sent to all destinations specified in the multicast API. This new API eliminates the need for applications to set up multicast groups prior to initiating the multicast, thus removing the inflexibility and administrative costs often associated with using such multicast groups. The new API further provides system call efficiency, accomplishing the complete multicast configuration and send in a single call.

It is also to be understood that aspects of the present disclosure may not necessarily address one or all of the issues noted in the Background above.

It can thus be seen that there are many aspects of the present invention, including particular additional or alternative features that will become apparent as this specification proceeds. It is therefore understood that the scope of the invention is to be determined by the claims and not by whether the claimed subject matter solves any particular problem or all of them, provide any particular features or all of them, or meet any particular objective or group of objectives set forth in the Background or Summary.

### BRIEF DESCRIPTION OF THE DRAWINGS

The preferred and other embodiments are shown in the accompanying drawings in which:

FIG. 1 is a block diagram of the internal structure of a computer system;

FIG. 2 is a block diagram of event systems and fast I/O event discovery methods implemented in conjunction with fast I/O according to an exemplary embodiment disclosed herein;

FIG. 3 is a block diagram of event system polling and I/O servicing threads in fast I/O event systems according to an exemplary embodiment disclosed herein;

FIG. 4 is a block diagram of event-driven systems implemented in conjunction with fast I/O event discovery systems according to an exemplary embodiment disclosed herein;

FIG. 5 is a block diagram of event-driven systems with queuing to application implemented in conjunction with fast I/O event discovery systems according to an exemplary embodiment disclosed herein;

FIG. 6 is a block diagram of a multiprocessor view of event-driven systems with queuing to application implemented in conjunction with fast I/O event discovery systems according to an exemplary embodiment disclosed herein;

FIG. 7A is a block diagram of event-driven systems with direct invocation of application event handler implemented in conjunction with fast I/O event discovery systems according to an exemplary embodiment disclosed herein;

FIG. 7B is a block diagram of event-driven systems with direct invocation of application event handler implemented in conjunction with fast I/O event discovery systems as shown in FIG. 7A combined with dedicated processors and parallel processing according to an exemplary embodiment disclosed herein;

FIG. 8A is a block diagram of methods of invoking application event handlers in system-space with shared memory according to an exemplary embodiment disclosed herein;

FIG. 8B is a block diagram of methods of invoking application event handlers using upcall according to an exemplary embodiment disclosed herein;

FIG. 8C is a block diagram of methods of invoking application event handlers using hardware IPC mechanisms according to an exemplary embodiment disclosed herein;

FIG. 9A is a block diagram of event-driven systems with queuing to application implemented in conjunction with either fast I/O event discovery systems or conventional operating system I/O stacks according to an exemplary embodiment disclosed herein;

FIG. 9B is a block diagram of event-driven systems with direct invocation of application event handlers implemented in conjunction with either fast I/O event discovery systems or conventional operating system I/O stacks according to an exemplary embodiment disclosed herein;

FIG. 10 is a block diagram of application polling with integrated event queue implemented in conjunction with fast I/O event systems according to an exemplary embodiment disclosed herein;

FIG. 11A is a block diagram of an event queuing system where both application and I/O event systems can act as event sources according to an exemplary embodiment disclosed herein;

FIG. 11B is a block diagram of a shared memory method used in queuing from application and queuing from I/O event systems in the event queuing system according to an exemplary embodiment disclosed herein;

FIG. 11C is a block diagram of a method of providing applications with queuing capability to event queues according to an exemplary embodiment disclosed herein;

FIG. 11D is a block diagram of an alternative method of providing applications with queuing capability to event queues according to an exemplary embodiment disclosed herein;

FIG. 11E is a block diagram of another alternative method of providing application with queuing capability to event queues according to an exemplary embodiment disclosed herein;

FIG. 12 is a block diagram of event distribution according to an exemplary embodiment disclosed herein;

FIG. 13A is a block diagram of event distribution combined with application polling with event queue, implemented in conjunction with a fast I/O event system according to an exemplary embodiment disclosed herein;

FIG. 13B is a block diagram of event distribution in an event-driven system implemented in conjunction with a fast I/O event system according to an exemplary embodiment disclosed herein;

FIG. 14 is a block diagram of event distribution with events of one socket or file-descriptor distributed to multiple queues and showing different distribution by event types according to an exemplary embodiment disclosed herein;

FIG. 15A is a process flow diagram of the round-robin event distribution destination selection method according to an exemplary embodiment disclosed herein;

FIG. 15B is a process flow diagram of load-balancing event distribution method according to an exemplary embodiment disclosed herein;

FIG. 15C is a process flow diagram of a cache-affinity event distribution method according to an exemplary embodiment disclosed herein;

FIG. 15D is a process flow diagram of a combined cache-affinity, flow-affinity and load-balancing event distribution methods according to an exemplary embodiment disclosed herein;

FIG. 15E is a process flow diagram of a flow-affinity event distribution method according to an exemplary embodiment disclosed herein;

FIG. 15F is a process flow diagram of application-supplied rules and logic event distribution methods according to an exemplary embodiment disclosed herein;

FIG. 15G is a process flow diagram of an event filtering method in an event system according to an exemplary embodiment disclosed herein;

FIG. 15H is a process flow diagram of another event filtering method in an event system according to an exemplary embodiment disclosed herein;

FIG. 16 is a block diagram of event queuing and light-weight task queuing by application event handlers according to an exemplary embodiment disclosed herein;

FIG. 17 is a block diagram of light-weight task queuing methods according to an exemplary embodiment disclosed herein;

FIG. 18 is a block diagram of multicast API's according to an exemplary embodiment disclosed herein;

FIG. 19A is a block diagram of fast task execution and distribution invoking hardware IPC mechanisms involving upcall according to an exemplary embodiment disclosed herein;

FIG. 19B is a block diagram of fast task execution and distribution invoking hardware IPC mechanisms without involving upcall according to an exemplary embodiment disclosed herein;

### DETAILED DESCRIPTION

The following description provides examples, and is not limiting of the scope, applicability, or configuration. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Broadly, the invention provides a system and methods for implementing a scalable event system in conjunction with fast I/O. In addition the techniques, methods and mechanism disclosed in this application can also be applied to traditional operating systems implemented on top of slow I/O. Such systems and integrations can reduce or eliminate context switching, while also improving scalability and providing powerful and flexible application programming interfaces.

Certain embodiments of the invention are described with reference to methods, apparatus (systems) and computer program products that can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

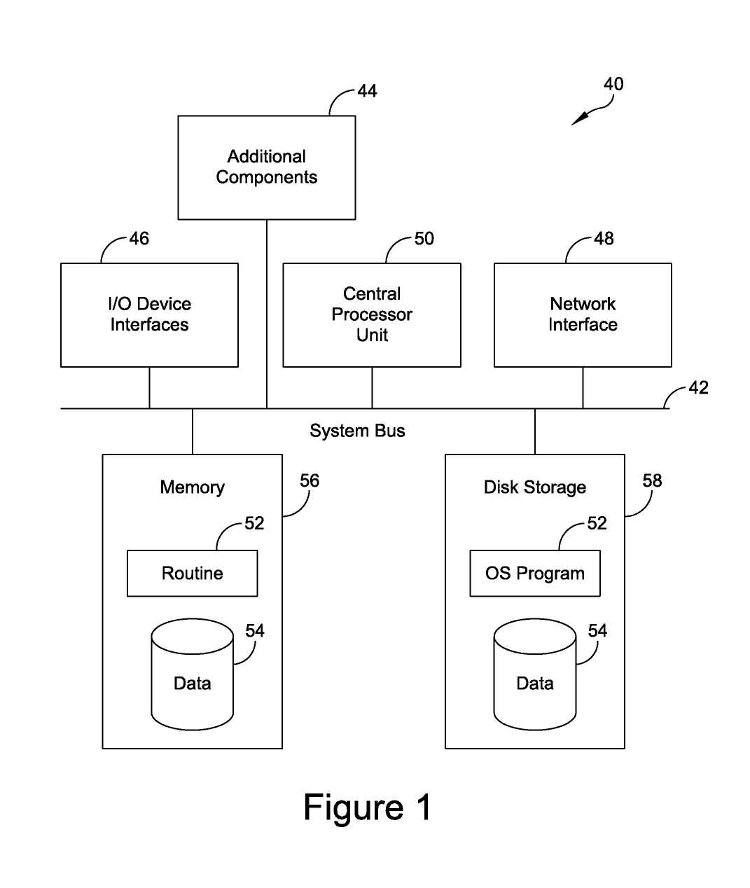

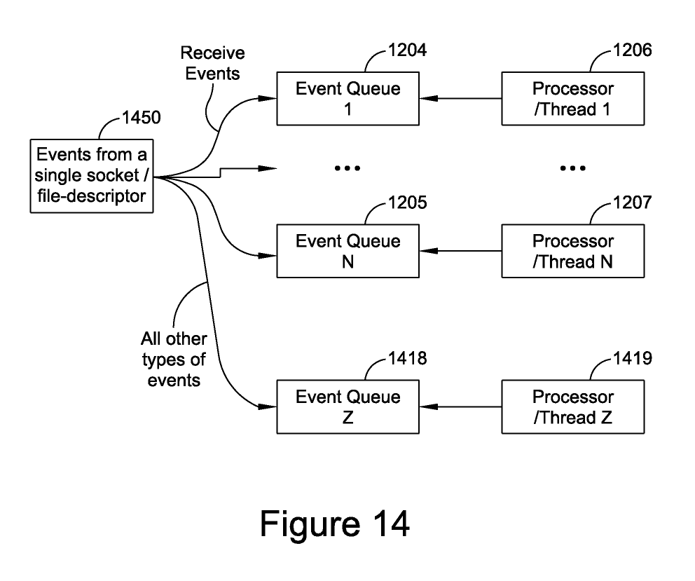

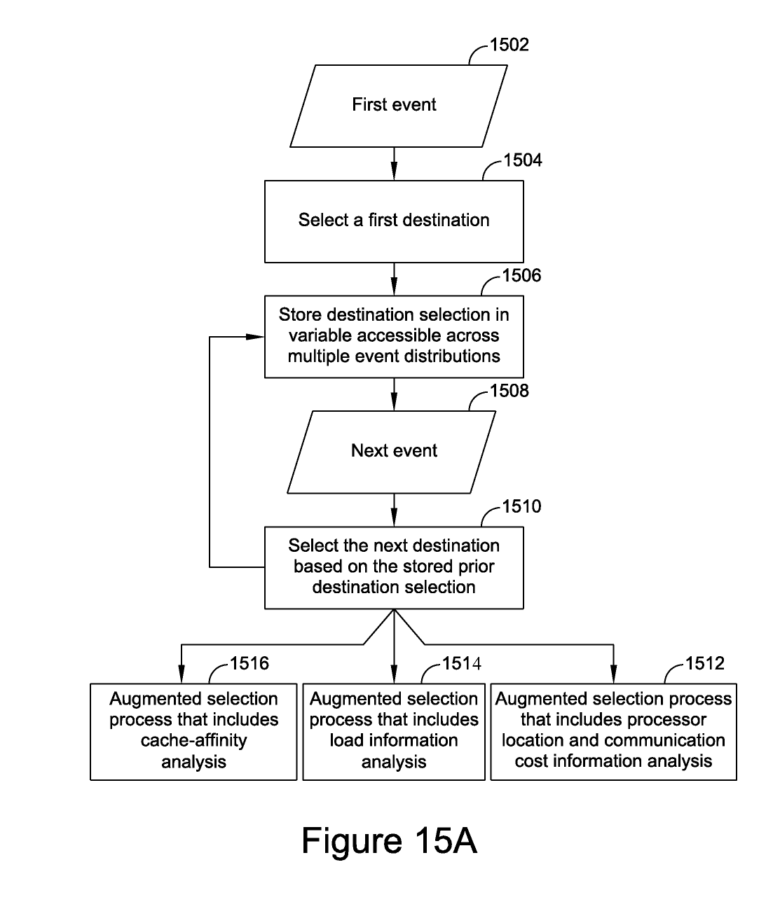

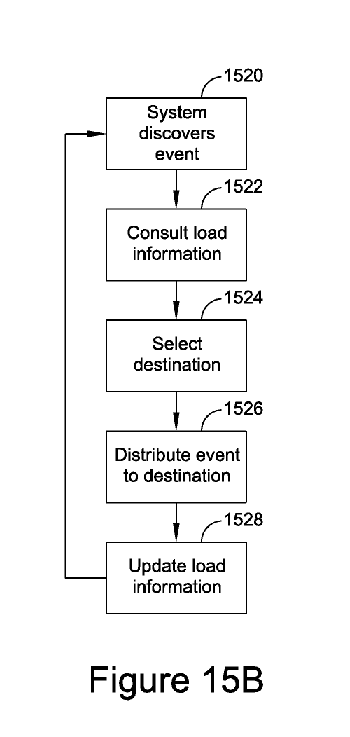

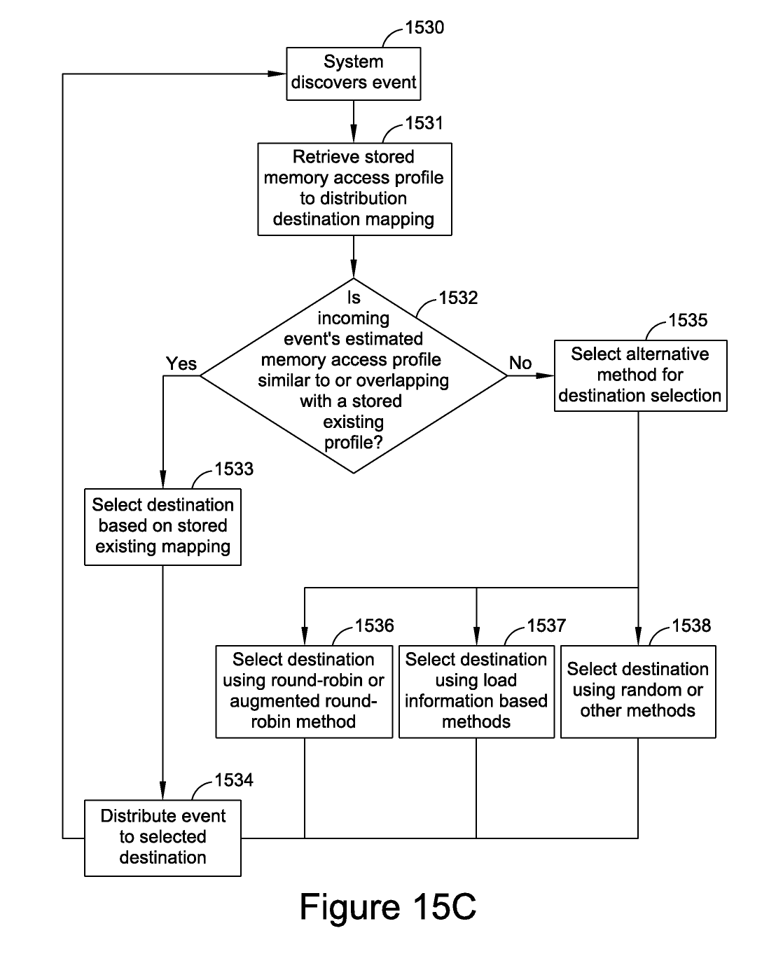

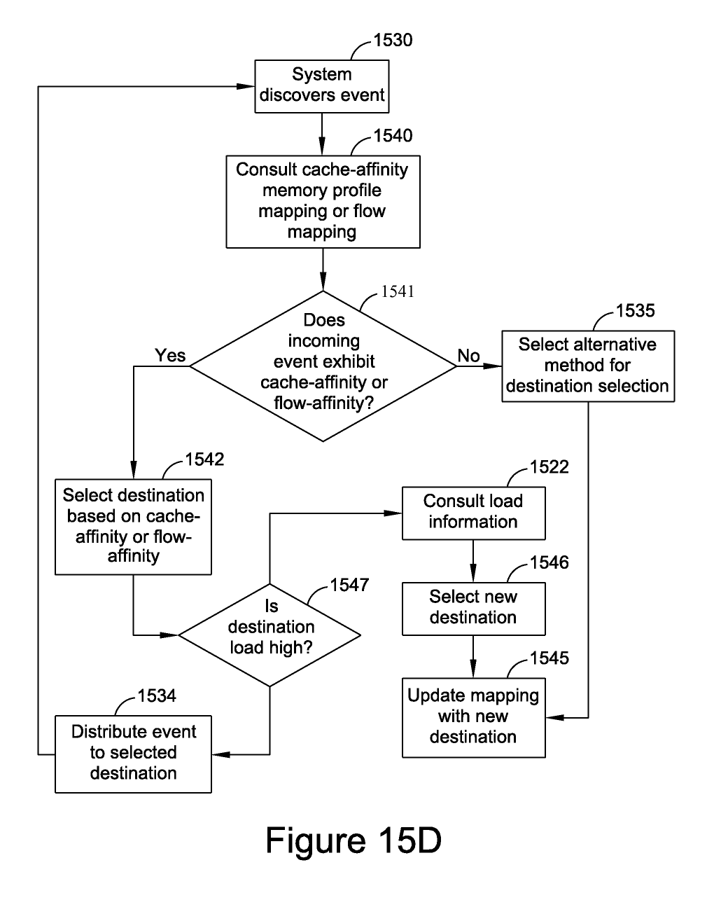

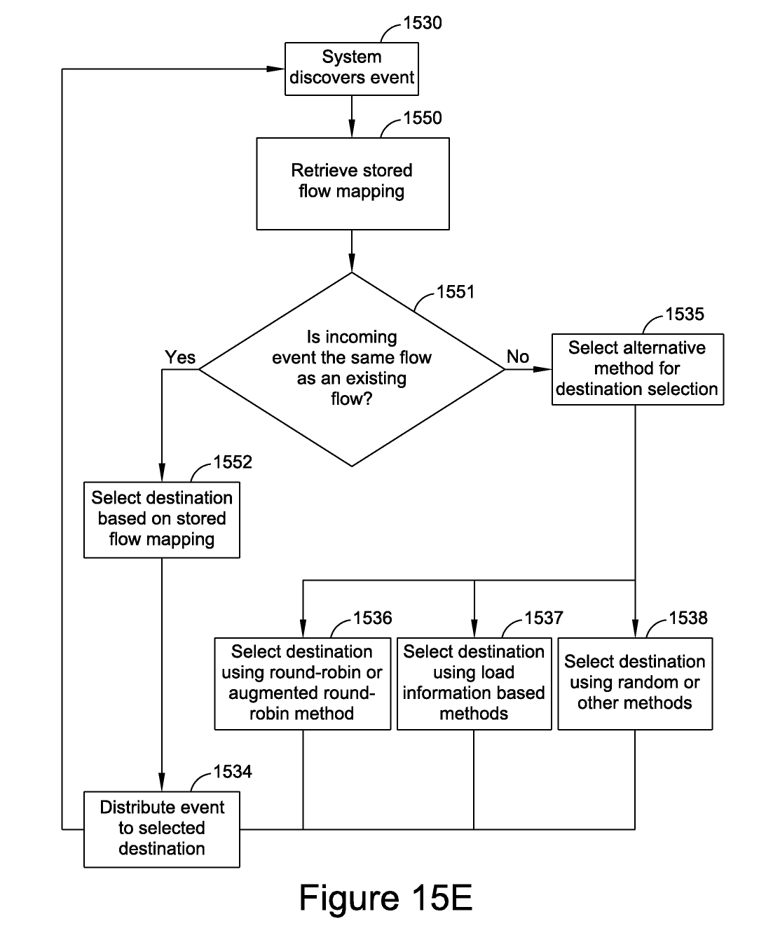

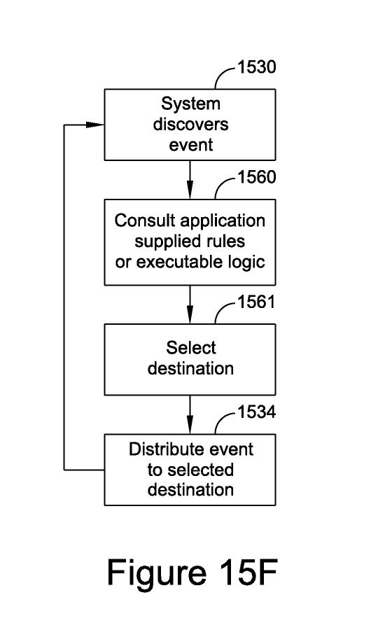

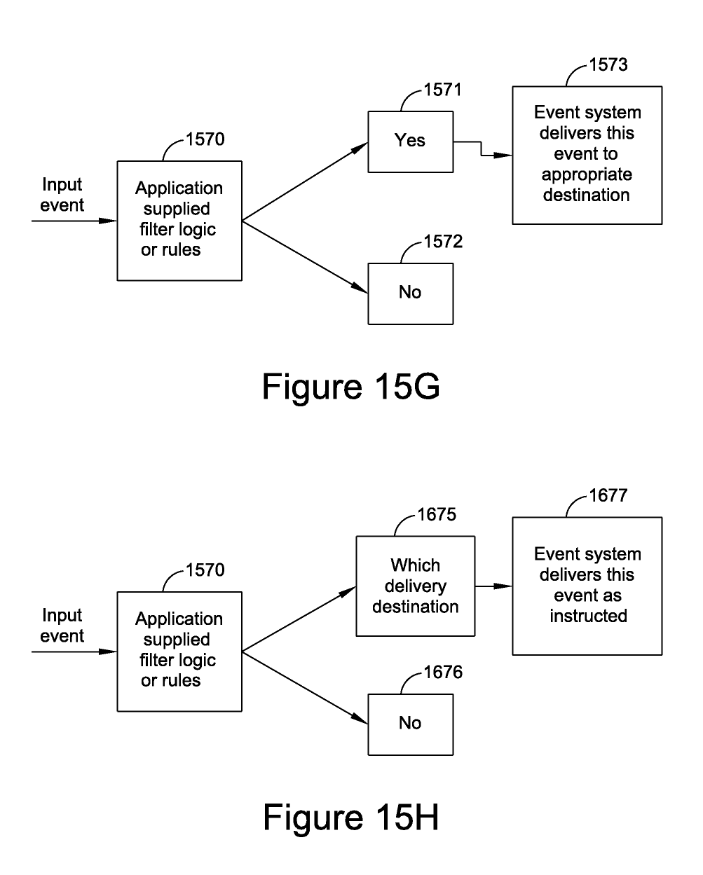

With reference to FIG. 1, each component of the system 40 is connected to system bus 42, providing a set of hardware lines used for data transfer among the components of a computer or processing system. Also connected to bus 42 are additional components 44 of the event system such as additional memory storage, digital processors, network adapters and I/O devices. Bus 42 is essentially a shared conduit connecting different elements of a computer system (e.g., processor, disk storage, memory, input/output ports, network ports, etc.) and enabling transfer of information between the elements. I/O device interface 46 is attached to system bus 42 in order to connect various input and output devices (e.g., keyboard, mouse, displays, printers, speakers, etc.) to the event system. Network interface 48 allows the computer to connect to various other devices attached to a network. Memory 56 provides volatile storage for computer software instructions 52 and data 54 used to implement methods employed by the system disclosed herein (e.g., the round-robin method in FIG. 14 and the cache-affinity distribution method of FIG. 15C) Disk storage 58 provides non-volatile storage for computer software instructions 52 and data 54 used to implement an embodiment of the method of the present disclosure. Central processor unit 50 is also attached to system bus 42 and provides for the execution of computer instructions.

In one embodiment, the processor routines 52 and data 54 are a computer program product, including a computer readable medium (e.g., a removable storage medium such as one or more DVD-ROM's, CD-ROM's, diskettes, tapes, etc.) that provides at least a portion of the software instructions for the system. Computer program products that combines routines 52 and data 54 may be installed by any suitable software installation procedure, as is well known in the art. In another embodiment, at least a portion of the software instructions may also be downloaded over a cable, communication, wireless connection or both.

Depending on the embodiment, certain acts, events, or functions of any of the methods described herein can be performed in a different sequence, can be added, merged, or left out all together (e.g. not all described acts or events are necessary for the practice of the method). Moreover, in certain embodiments, acts or events can be performed concurrently (e.g., through multi-threaded processing, interrupt processing, or multiple processors or processor cores) rather than sequentially. Moreover, in certain embodiments, acts or events can be performed on alternate tiers within the architecture.

1. Event System Polling Mechanisms in Conjunction with Fast I/O

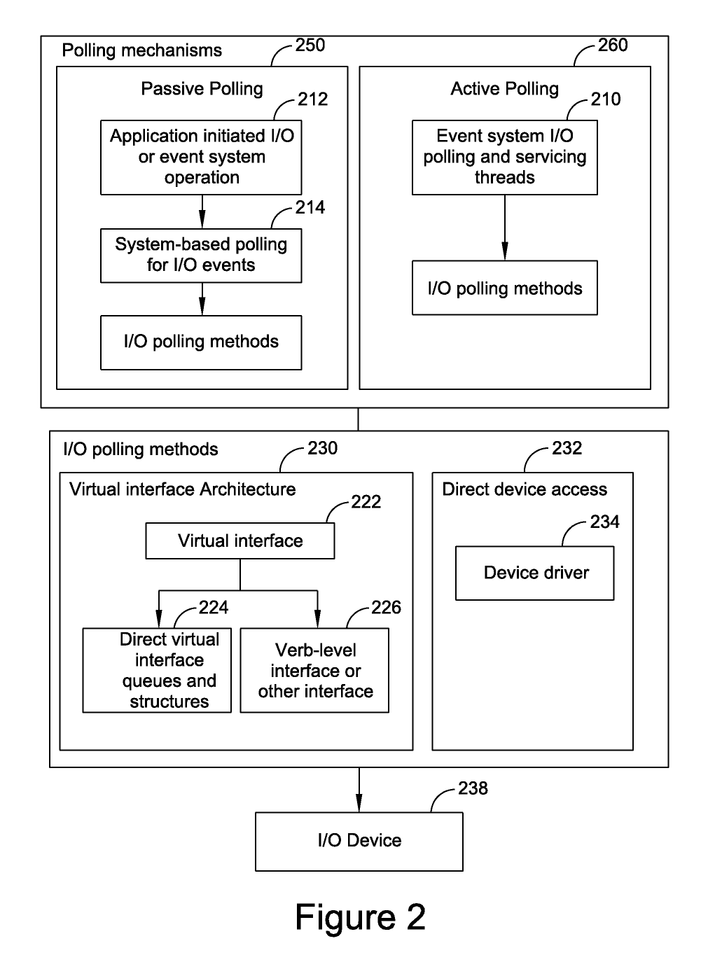

Various embodiments of the invention will now be described in more detail. In event systems that are implemented in conjunction with fast I/O, I/O events are generally discovered through polling. These systems either employ active or passive methods to poll for I/O events. Referencing now FIG. 2, in active systems 260, there are one or more dedicated threads that continuously poll for I/O events 210. Alternatively, the system can be passive 250. In passive systems, the system does not itself have active threads that are continuously polling, but instead, will poll when an application issues an I/O or event system operation 212 that causes the system to poll for I/O events 214. Examples of I/O and event operation APIs include recv( ) and select( ), poll( ), or epoll( ) calls. Whichever method is used, all I/O polling eventually reaches the I/O devices 238 and checks the state of queues or other statuses associated with the I/O devices.

In some embodiments, polling and discovery of I/O events are done through a virtual interface (“VI”) 222. The system can poll directly on the VI 222 through the use of such mechanisms as send and receive queues, work queue elements, completion queues, etc. 224. The system can poll at any level of an API or library interface on top of the base queuing and other structures of the VI 226. If the VI 222 is exposed by an I/O device that implements the Virtual Interface Architecture (“VIA”) 230 or equivalent, the system may poll using the Verbs interface 226, which is a relatively low-level interface directly on top of the VI elements and structures.

In some embodiments, the VI 222 is provided by the I/O device 238. An example would include the case where the NIC hardware implements the VI 222. In other embodiments, the VI 222 is provided by software, or alternatively by a combination of hardware and software. An example of such an implementation is the combination of NIC firmware and software that run on the host system. In the case where VI 222 is provided by an I/O device 238 or a combination of software and hardware, the underlying I/O device 238 provides some features of the VIA 230 or equivalent architecture. In the case where the VI 222 is provided purely in software, the software stack virtualizes the underlying I/O devices, and the underlying I/O device 238 need not have features of the VIA 230 or equivalent architecture.

In another embodiment, the system has direct access 232 to the underlying I/O devices through such mechanisms as device drivers 234. The system can poll for the state of devices directly without the use of VI software layers or reliance on particular I/O device VIA feature implementations. With access to devices, device drivers 234, or both, the event system can be implemented in either user-space or in kernel-space.

In some of these embodiments where the system discovers I/O events primarily through polling, interrupts can be disabled for the I/O device polled by the polling mechanism. In a fast I/O and event system that employs the above polling mechanisms as the primary event discovery mechanism, when interrupt is used, it is only used as secondary mechanism for the purpose of waking up a polling thread that is in wait mode. For example, the system can put polling threads into wait mode when there are no I/O events or I/O activities for a period of time (e.g. longer than some threshold). The waiting threads needs to be awakened when I/O events are present. Interrupts are used to awaken the waiting threads. In some of these embodiments, after the polling threads are awakened, the system resumes polling as the primary I/O event discovery method, disabling interrupts. In contrast, conventional operating systems use interrupts as the primary event discovery mechanism and incur the overhead associated with context switching that occurs along the I/O servicing and event discovery paths.

Demultiplexing can determine application association for an incoming event. Demultiplexing can be performed in different places with respect to event discovery, depending on the implementation. After demultiplexing, the event system delivers the I/O event to its appropriate destination.

In some embodiments, the necessary protocols processing is completed before the application event handlers are invoked. The necessary protocols to process depend on application specification and configuration. For example, a socket may be a TCP socket over an IP network, in which case at least TCP and IP protocols are processed. If the application demands access to the raw packets and specifies that the system should not process any protocol, the system may not perform any protocol processing. Protocol processing may then be performed before event delivery or after event delivery or in combination (e.g. some portion before delivery and some portion after delivery).

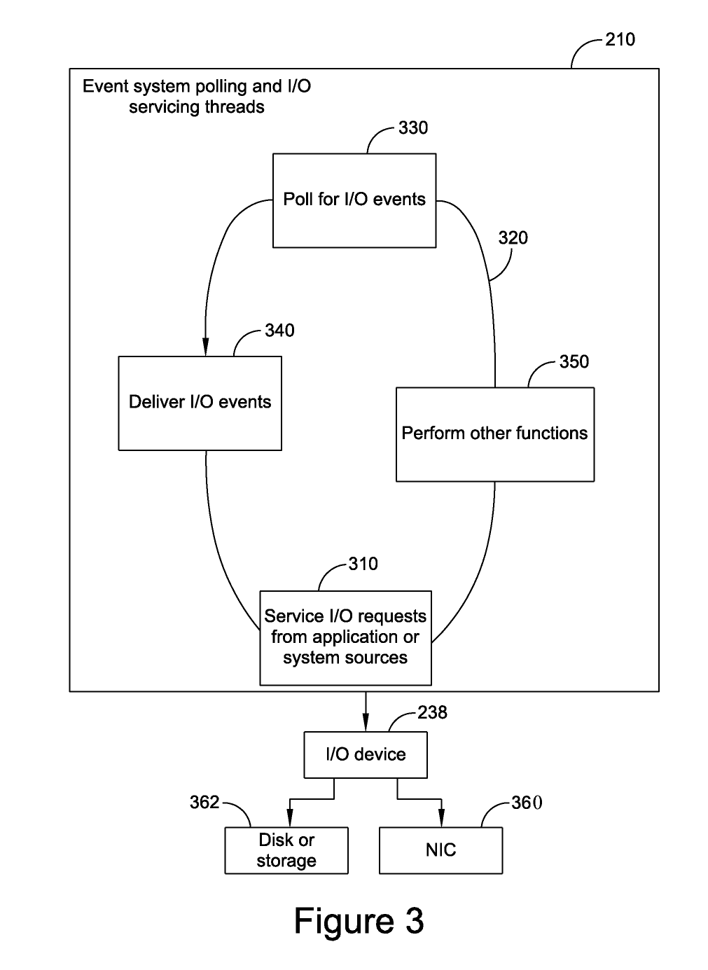

In some embodiments, the event system has one or more dedicated threads 210 that continuously poll for I/O events in accordance with the polling methods previously discussed. Threads supplied by the event system that poll for I/O events and perform I/O event discovery and delivery are referred to as “event system polling and I/O servicing threads” 210 to distinguish them from other polling threads that may be provided by the event system. Referring now to FIG. 3, the event system polling and I/O servicing threads repeatedly poll for I/O events 330 by, for example, running a polling loop 320 that repeatedly calls device drivers or queries the state of virtual interfaces and delivers I/O events 340. Each polling thread continuously polls so long as it is active and not in a waiting mode. These threads have direct access to devices 238 or device drivers or virtual interfaces, depending on the access method implemented as previously discussed. The event system polling and I/O servicing threads may also service I/O requests, including those that come from application sources or other system sources 310. In some embodiments, the polling threads may perform operations unrelated to I/O 350.

Each event system polling and I/O servicing thread 210 can interface with, and service, one or more I/O devices or virtual interfaces 238. In some embodiments, multiple event system polling and I/O servicing threads 210 can be grouped into a single entity. The devices, virtual interfaces, or both that each system polling and I/O servicing thread 210 or entity interface with and service can be of one or more types. For example, one system polling and I/O servicing thread or entity can serve both network devices (e.g. NIC's) 360 and block devices (e.g. disk or storage) 362.

In some embodiments, each event system polling and I/O servicing thread 210 polls on a different set of I/O devices 238 or device ports. In some embodiments, multiple event system polling and I/O servicing threads 210 can poll on the same set of I/O devices 238 or device ports, and thus these multiple polling threads are a single entity. In yet another embodiment, the set of I/O devices 238 or device ports polled by different polling threads overlap.

There can be one or more such event system polling and I/O servicing threads 210 or entities in a system, and these threads can act concurrently and in parallel. An application can interact with one or more of these event system polling and I/O servicing threads 210. One or more of such event system polling and I/O servicing threads 210 can interact with a particular application. One or more events can be retrieved at any single polling iteration. In some embodiments, event system polling and I/O servicing threads 210 are implemented in the same address-space as the application. In other embodiments, the event system polling and I/O servicing threads 210 are implemented in a different address-space from that of the application address-space, wherein this different address-space can be in either user-space or kernel-space.

In some embodiments, the event system pins the polling and I/O servicing threads 210 to specific processors 638, 640, or more generally, dedicates processors to one or more such threads. The event system polling and I/O servicing threads 210 running on dedicated I/O servicing processors 638, 640 can run for an extended period of time generating a stream of I/O events. In some embodiments, the event system utilizes partitioned resource management policies where the system polling and I/O servicing threads 210 run on one set of dedicated processors 638, 640, while the application or application logic threads run on a different set of processors 642, 644. The partitioning of processors facilitates concurrent processing by allowing resources to be dedicated to specific processing activities. In some embodiments, multiple event system polling and I/O servicing threads 210 exist in a system, and each such thread is pinned to a different processor, thus parallel processing can execute more efficiently with better cache locality and less scheduling interference. In some embodiments, the dedication of processors and partitioning of processor resources is combined with event distribution described later in this application, creating even more granular configuration options and further enhancing parallel processing efficiency as a result.

In some embodiments, the application configures the dedication of processors and partitioning of resources. For example, system-provided API's or configuration file equivalents specify a mapping of I/O devices to the processors that run the event system polling and I/O servicing threads 210. The system pins the event system polling and I/O servicing threads 210 onto the processors in accordance with this mapping, moving other processes or threads to other processors. Alternatively, the system selects the processors to run the event system polling and I/O servicing threads 210, thus generating the configuration automatically. In some embodiments, the pinning of threads, the dedication of processors to the polling threads, or both is achieved by using a combination of operating system API's and tools that assign process or thread priorities, processor affinities, interrupt affinities, etc.

In some embodiments, the I/O polling and event discovery methods, and the event system mechanisms disclosed in this section form a foundation for the event system disclosed subsequently. Whenever this disclosure references the event system in conjunction with fast I/O, or references fast I/O event discovery methods and system, such references refer to the system and methods disclosed here above in this section.

2 Event-Driven Mechanisms in Event Systems

Some embodiments of this invention employ event-driven models. In event-driven models, the event system invokes the appropriate application handler at the time of event discovery, or alternatively, after event discovery. In contrast to application polling methods, the application is not continuously polling for events. If any polling occurs, such polling is accomplished by the event system and referred to hereafter as system polling. In event-driven systems, the event system supplies the polling threads and optionally the executable logic segments operable to perform such polling, hereafter referred to as system polling threads. The application supplies event handlers and configures event interests as disclosed subsequently.

2.1. Event-Driven Mechanisms of Event Systems in Conjunction with Fast I/O

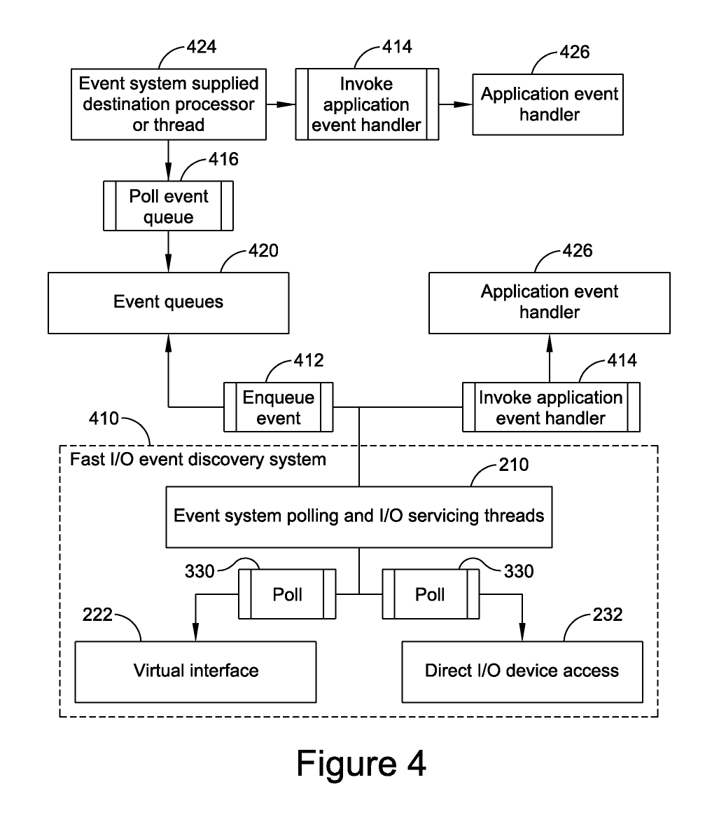

The event system in conjunction with fast I/O has been described previously, which is incorporated here by reference. Referring now to FIG. 4, in some embodiments, the event system provides the polling and I/O servicing threads 210 that continuously poll for I/O events 330. In some embodiments, after event discovery, the event system polling and I/O servicing thread 210 enqueues the event to the queue associated with the destination application processor or thread 412, 420. The destination processor or thread 424 polls the queue 416 and invokes the appropriate application event handlers 414. In some other embodiments, after event discovery, the event system polling and I/O servicing threads directly invoke the application event handler 426. As discussed previously, in the case of application polling methods, the event system polling and I/O servicing threads 210 may reside in the same address-space as the application, or alternatively in a different address-space from the application in user-space, wherein this different address-space can be in either user-space or kernel-space. In some embodiments, multiple event system polling and I/O servicing threads and entities work in parallel.

2.1.1 Event-Driven Mechanism of Event System with Queuing to Application

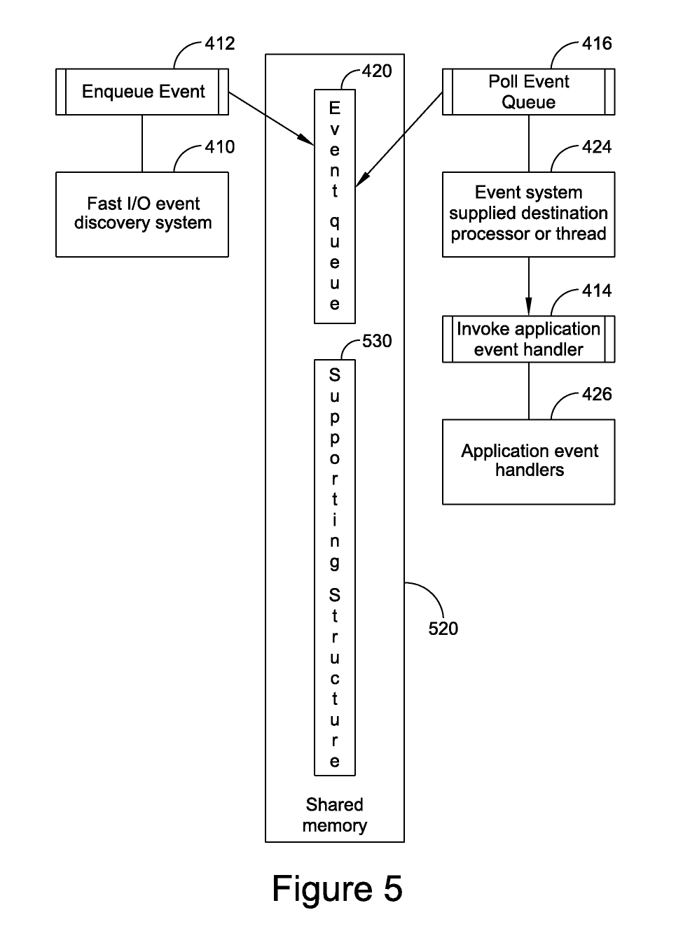

The event system in conjunction with fast I/O has been described previously, which is incorporated here by reference. Referring now to FIG. 5, in some embodiments, discovered events are queued to queues 420 by the event system I/O polling and servicing threads 210. The queues are associated with application destinations. The event system supplies another distinct polling thread 424 different from the I/O polling and servicing threads 210, which lives in the destination application address-space and polls the queue 420. After retrieving one or more queued events, application event handlers 426 are invoked in the application address-space by the system-supplied destination polling thread 414, 424. In these embodiments, the polling threads 424 polling the queue 420 at the destination live in the same address-space as the application. The application event handlers 426 automatically have access to application memory and context, and therefore application event handlers 426 are invoked by calling the application handler functions directly 414.

In various embodiments, event delivery is accomplished without context switching. In some of these embodiments, the fast I/O event discovery system 410 lives in the same address-space as the application, and event delivery is without context switching simply by virtue of residing in the same address-space. In other of these embodiments, the fast I/O event discovery system 410 lives in a different address-space from the application, whether said different address-space is in user-space or kernel-space, and shared memory is mapped into both address-spaces 520. The shared memory region mapped includes one or more queues 420 and may include all supporting structures 530 for the enqueuing and retrieval of events. Supporting structures 530 include such structures as, for example, event objects that are to be enqueued and allocated from the shared memory space. Both the fast I/O event discovery system 410 and the application have direct access to the queue using shared memory 520. Thus, polling 416 and dequeuing of the queued events by the destination processor from the application address-space can be accomplished without context switching. Enqueuing to the queues 412 by the fast I/O event discovery system 410 is also accomplished without context switching through the shared memory 520.

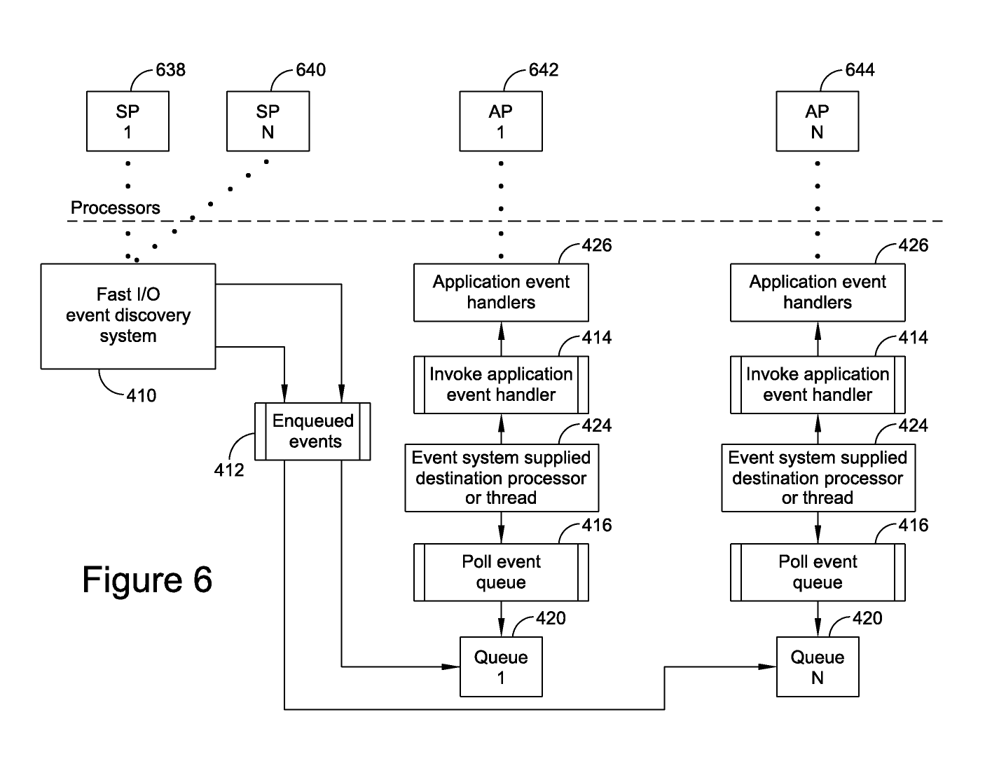

Referring now to FIG. 6, in some embodiments, the fast I/O event discovery system 410 has one or more event system polling an I/O servicing threads 210 associated with one or more dedicated processors 638, 640. These system polling and I/O servicing threads 210 may execute in parallel and concurrently on multiple processors. The set of processors dedicated to the event system polling and I/O servicing threads 210 are distinct from the application processors 642, 644. The system I/O processors 638, 640 and application processors 642, 644 may act concurrently.

In some embodiments, the event system supplied destination threads in the application address-space 424 are runtime programs involved in scheduling application tasks and in events processing, while the event system polling and I/O servicing threads 210 are involved in I/O event discovery and processing 410. In such an embodiment, event system polling and I/O servicing threads 210 can be viewed as specialized I/O event and message processors, while the event system supplied destination threads 424 can be viewed as application logic processors. The specialized I/O event and message processors are directing events to application logic processors. Such embodiments can be combined with event distribution to multiple destination processors disclosed subsequently, and create systems designed to take full advantage of multiprocessing environments. There can be one or more intermediate queues and polling threads that further direct and distribute events, and there may be one or more queues and polling entities at each step of this directing and distribution, and any combination thereof.

2.1.2 Event-Driven Mechanism of Event System with Queuing to System

The event system in conjunction with fast I/O has been described previously, which is incorporated here by reference. In some embodiments, discovered events are queued by the event system I/O polling and servicing threads 210 to queues 420 associated with system destinations. These system destinations, for example, may be other system polling and I/O servicing threads 210, or other threads of the system implementing different functions, protocols, etc. The destination can be any system or subsystem, and is not restricted to I/O or event systems (e.g. they can be scheduling or other systems or subsystems). In some of these embodiments, there can be one or more steps of such queuing. The polling threads at the system destination in the system address-space poll the queues. After retrieving one or more queued events, application event handlers are invoked by the system-supplied destination polling thread 424.

In some embodiments, the system destination is in the same address-space as the fast I/O event discovery system 410. In this case, event delivery to other parts of the event system does not require moving across address-spaces (i.e. moving to and from system-space and user-space), thus no context switching occurs. In other embodiments, the source fast I/O event discovery system 410 and the destination system threads live in different address-spaces. In such cases, shared memory 520 is implemented as described in the previous section. Both the event system and the application have direct access to the memory, and therefore access to the queues and structures 420, 530 contained therein. Thus, enqueuing and dequeuing occurs without context switching.

In some embodiments, the event system supplied destination threads 424 that invoke the application handler live in the same address-space as the application. The application event handlers automatically have access to application memory and context, and therefore application event handlers are called directly. In other embodiments, the system destination that invokes the application event handler resides in a different address-space than the application. In such cases, the event system provides facilities for the application to access application memory. These facilities are discussed in detail in later section 2.1.3.1 and are included here by reference.

In some embodiments, the event system with queuing to system is implemented in conjunction with the dedication of processors as described previously. In various of these embodiments, one or more system polling and I/O servicing threads 210 exist in the fast I/O event discovery system, and one or more processors 638, 640 are dedicated to one or more of the event system polling and I/O servicing threads 210. Each of these threads can discover and process I/O events in parallel. In addition, one or more event system supplied destination threads 424 and tasks may exist in the event system, and can be executing on a distinct set of processors from the processors dedicated to the event system polling and I/O servicing threads 210. Multiple application event handlers 426 can be invoked concurrently in the system by different system threads executing in parallel.

In some embodiments, the queuing to system functionality is implemented in conjunction with the queuing to application functionality, for example, where one or more queuing steps to other parts of the system are followed by queuing to an application destination.

2.1.3 Event-Driven Mechanism of Event System with Direct Invocation of Event Handlers

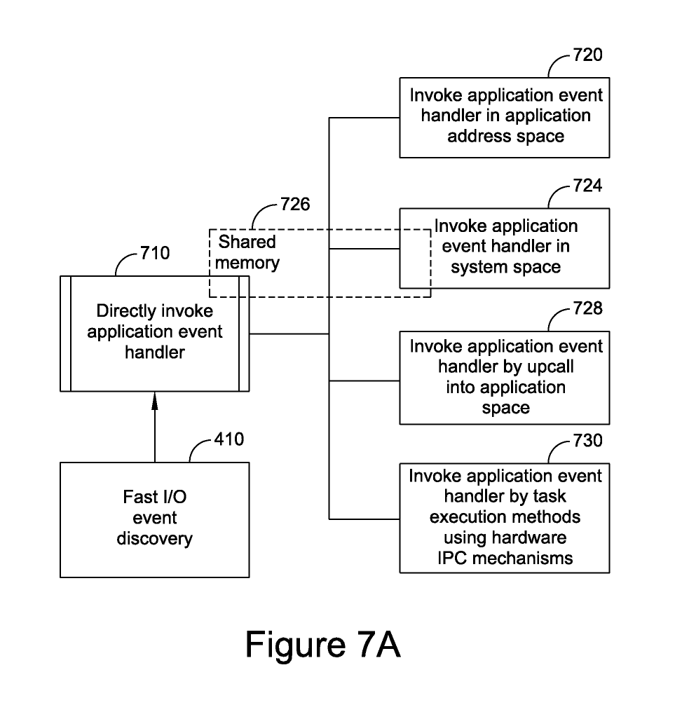

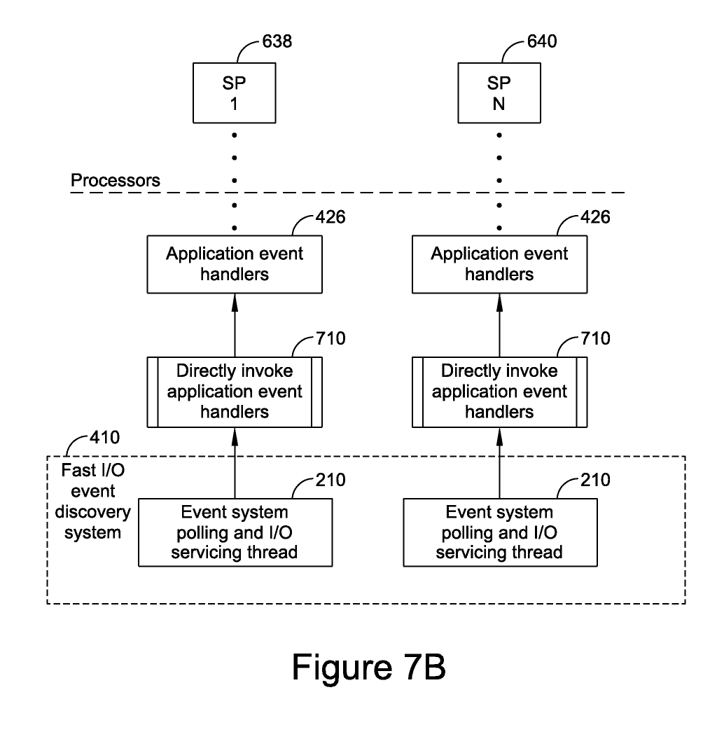

The event system in conjunction with fast I/O has been described previously, which is incorporated here by reference. Referencing now FIG. 7A, in some embodiments event system polling and I/O servicing threads 210 directly invoke the application event handler after event discovery 710. The event system provides several methods for direct invocation of application event handlers 426. In some embodiments, when I/O system and event discovery mechanisms 410 and application event handlers 426 both reside in the same address-space as the application, application handlers can be called directly 720. In other embodiments, I/O system and event discovery mechanisms 410 do not reside in the same address-space as the application. In such cases, the system provides facilities for applications to access application memory. Application event handlers may be invoked in system space 724, with shared memory 726 facilitating its access to application memory as described in section 2.1.3.1 and incorporate here by reference. Alternatively, application event handlers may be invoked by upcall into the application address-space 728. Yet another alternative method involves task execution using hardware inter-processor communication (“IPC”) mechanisms 730. These methods of event handler invocation 724, 728, 730, are described in section 2.1.3.1, and are included here by reference.

In some embodiments, enhanced application event handler API's as discussed in detail in section 2.5 and included here by reference are implemented in conjunction with the direct invocation mechanism described herein. In some embodiments, the event system with the direct invocation mechanism is combined with the dedication of processors as described previously. Referencing now FIG. 7B, in various of these embodiments, one or more system polling and I/O servicing threads 210 exists in the fast I/O event discovery system 410, and one or more processors 638, 640 may be dedicated to one or more of the system polling and I/O servicing threads 210. Multiple application event handlers 426 may be invoked 710 concurrently in the system by different event system polling and I/O servicing threads executing in parallel.

2.1.3.1 Methods of Invocation of Application Event Handlers

This section describes methods for the invocation of application event handlers by threads running in the system address-space different from the application address-space. Embodiments including one or more of these methods provide application event handler execution with access to application memory.

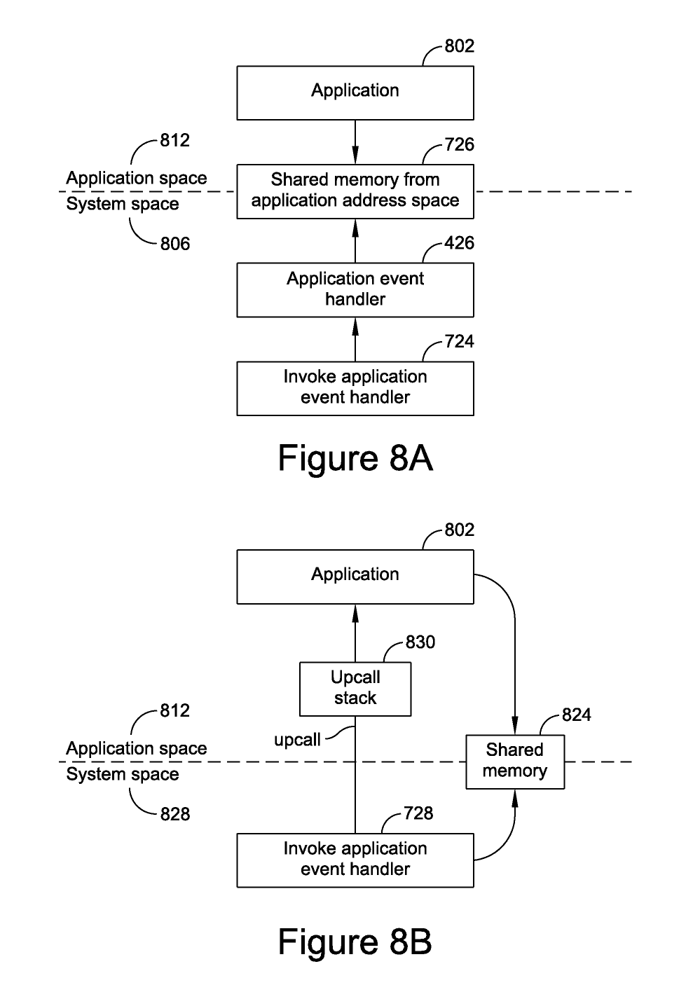

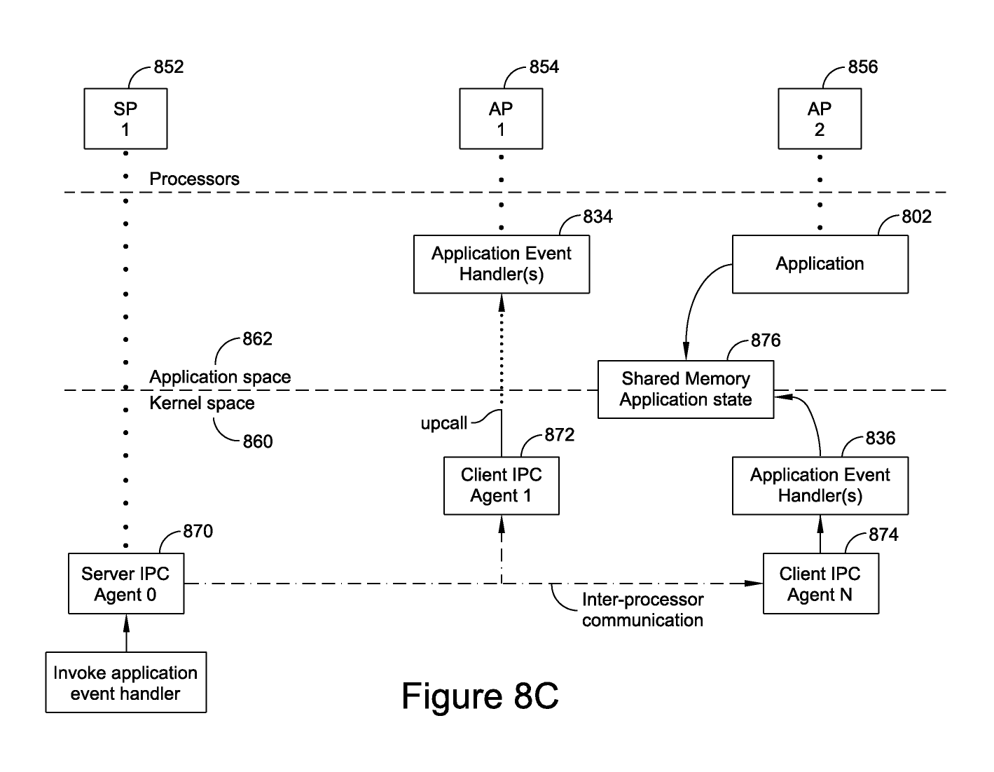

Referencing now FIG. 8A, in some embodiments, shared memory 726 is used to give application event handlers 426 access to application memory. Application memory is mapped into the system address-space 806, giving application event handlers 426 direct access to the shared application memory 726 mapped into system-space 806. In some of these embodiments, the shared memory 726 can be setup beforehand. For example, the application 802 may configure or otherwise register application memory accessed by application event handlers 426 using system-supplied facilities to perform such configuration. The event system can use memory mapping functions such as mmap( ) to automatically map shared memory 726. Such shared memory and invocation methods can be used when the I/O event system executes in a separate address-space from the application in user-space, whether such separate space is kernel-space or user-space When the system executes in kernel-space, the event system may also provide automated compilation facilities, linking facilities, or both to help the application event handler 426 to be executable in kernel-space.

In some embodiments the application event handler 426 executing in system-space 806 can access one or more of the API libraries that the application 802 would normally have the ability to access when executing in application space 812. Application event handlers 426 invoked from system-space 806 have access to pertinent application states through the shared memory mapping 726 and execute without context switching.

Referring now to FIG. 8B, in another embodiment, the I/O event system and mechanisms are implemented in kernel-space, or otherwise have corresponding privileges, and upcall into the application address-space 812 to invoke application event handlers 728. In this case, the application handler 426 is executed in application-space and context, and has access to all application states, even though it is invoked from system-space 828 that executes in kernel-space. Parameters of the upcall can be passed through the upcall stack 830. Upcall can be used in conjunction with a shared-memory area 824 for passing large-sized parameters. This combination provides performance benefits by avoiding the copying of large-sized parameters into the upcall stack 830.

Referring now to FIG. 8C, in yet another embodiment, when the I/O event system and mechanisms are implemented in kernel-space 860, or otherwise have the privilege to use hardware IPC mechanisms, tasks are executed using hardware IPC mechanisms. The event system uses the server IPC agent 870 to send IPC requests from one processor 852 to one or more other processors 854, 856 to directly invoke application event handlers 834, 836 from kernel-space 860. Upon receiving the IPC requests, client IPC agents 872, 874 execute, and use either upcall to invoke application event handlers 834 that execute in the application address-space 862, or directly invoke application event handlers 836 that execute in kernel-space 860 and have access to the necessary application state through shared memory 876.

2.2 Event Driven Mechanisms Applicable to Traditional I/O

In some embodiments, event-driven features and methods as described previously are applied to conventional operating systems independent of the presence of a fast event discovery and I/O system 410.

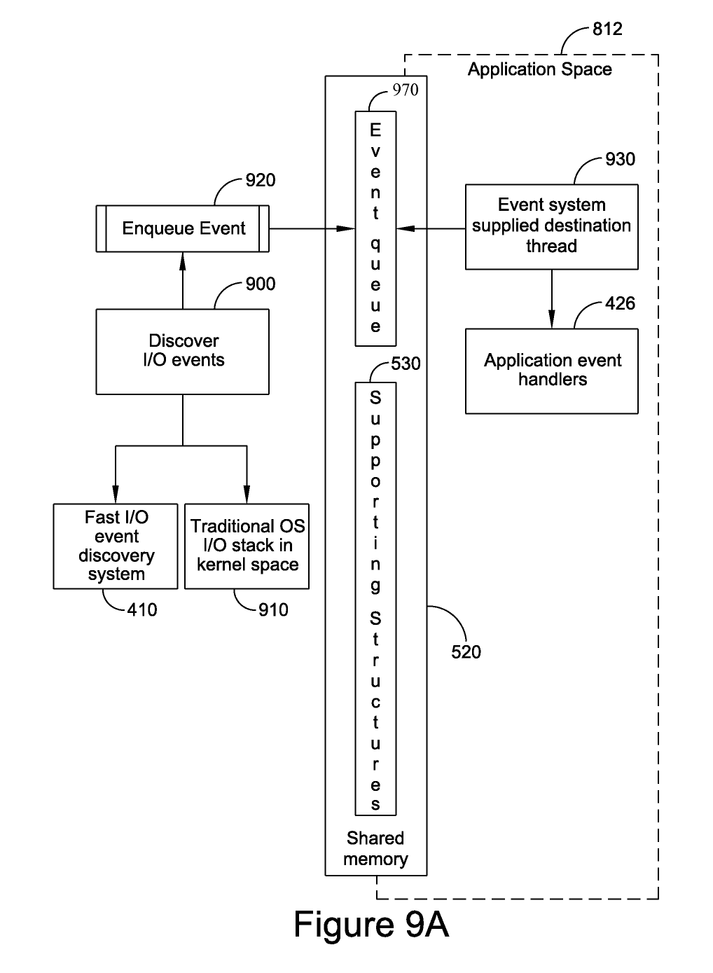

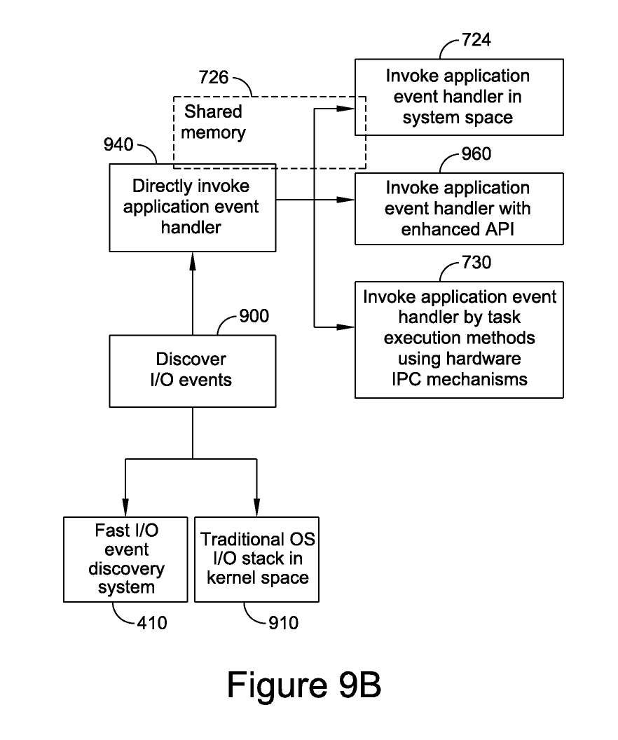

In some of these embodiments, utilizing the queuing to application model as discussed previously, the event delivery to application destinations occurs without context switching through the implementation of shared memory methods. In the case where the shared memory event delivery methods are applied to traditional operating systems, the event system space is the kernel-space. FIG. 9A illustrates a shared memory method of event delivery between the operating system kernel I/O stack 910 or fast I/O event discovery system 410 in kernel-space, and the user application-space. Shared memory 520 is mapped into both the kernel-space and the user application-space 812. The shared memory region mapped will at least include the queue 970 and can include some or all supporting structures 530 for enqueuing and retrieval of events. Supporting structures can, for example, include event objects that are to be enqueued and allocated from the shared memory space. Both the traditional operating system I/O stack 910, which executes in kernel-space, and the user-space application have direct access to the queues 970 using shared memory 520. Polling and retrieval of the queued events from application address-space 812 can be done without context switching. Through the shared memory 520, enqueuing to the queues is also accomplished without context switching. Thus it can be said that event delivery to application destination occurs without context switching.

In various of these embodiments, the methods of invocation of the application event handler 426 from system-space, and in particular, the method of using shared memory mapping to give application event handlers executing in system-space access to application memory are applied to traditional operating systems. The description of FIG. 8A in section 2.1.3.1 applies in the case of traditional operating systems as well, and is included here by reference. In this case, the system-space is the kernel-space.

In some of these embodiments, the methods of invocation of the application event handlers from system-space, and in particular, the method of using executing application event handlers as tasks using hardware IPC mechanisms, as in FIG. 8C and section 2.1.3.1, are applied to traditional operating systems. Methods of executing tasks using hardware IPC mechanisms are disclosed in detail in section 8, and included here by reference.

In various of these embodiments, the application event handler API's as described in section 2.5, in conjunction with the methods for invoking application event handlers as described above, are applied to traditional operating systems.

Referring now to FIG. 9B, in some embodiments, direct invocation of application event handlers is applied to traditional operating systems as described above. After I/O event discovery 900, application event handlers are directly invoked from the system 940. The invocation may use the direct invocation method with shared memory from application-space mapped into system-space 724, 726. Alternatively, the invocation may execute application event handlers using hardware IPC mechanisms 730, and the execution mechanisms as described in section 8. Either invocation method can be combined with the enhanced event handler API features 960.

2.3 Configuration and Binding

In some embodiments, application handlers to events and to other information such as queuing destinations (e.g. queues processors, threads, processes, etc.) are configured by the application. In some embodiments, the event system provides API's, other facilities, or both operable to perform this configuration. The configuration, binding functions and facilities described in this section can be applied to all the previously-discussed event system embodiments.

In one embodiment, binding of event handlers and other information such as the queuing destination does not involve applications posting individual asynchronous I/O operations. For example, handlers and destination information such as queues or destination processors or threads, are set for a file descriptor or set of file descriptors, for a type or set of types, for virtual interfaces, for queue pairs, for work pairs, etc. at any level that is higher than individual I/O operation, and for any combination thereof. More sophisticated rules, wild-cards, predicates, filters, etc. can be used. Once configured, the system delivers events upon event discovery and invokes the application event handlers when appropriate without the need for applications to post individual asynchronous I/O operations.

In another embodiment, the configuration and delivering of events by the system follows a post-and-complete event model. The binding of event handlers and other information such as queuing destinations can be set for individual asynchronous I/O operations. Binding can also work at a coarser level, for example, setting the event handler to invoke at the level of work queues, file descriptor, or completion queue. Individual asynchronous I/O operation postings occur before completion events are delivered in these AIO-like, post-and-complete event models. Upon completion of a posted I/O operation, the completion event is delivered to the application by invoking the application event handlers according to the configuration.

2.4 Device Resource Partitioning

In the above disclosed various models and embodiments, there are cases where the fast I/O event discovery system 410 lives in the same address-space as the application 802. In an embedded system, which usually only has one application instance, this is not normally an issue. In a general-purpose operating system environment, where there may be multiple applications or application instances, the event system provides additional facilities for embodiments where the fast I/O event discovery system 410 polls on I/O devices directly rather than through virtual interfaces, namely, device partitioning.

Device partitioning includes facilities for the mapping of devices to applications. Devices can be configured and assigned exclusively to an application, where the device is not shared by other applications. When the device is exclusively assigned to an application, the fast I/O event discovery system 410 that polls on I/O devices directly can be in the same address-space as the application to which the device is assigned.

2.5 Application Event Handler API's

In some embodiments, event handler API parameters provide the descriptor of the I/O object associated with the I/O event to the application when the event handler is invoked. For example, for network events, the socket that the event is associated with is provided to the application. In this case, demultiplexing is done by the system before invocation of the application event handler. In some embodiments, protocol processing is done by the system prior to the invocation of event handlers. In some embodiments, application message payload, rather than the raw message, is provided to the application. In other embodiments, the raw message may be provided to the application at the application's request or if the system is so configured.

The I/O object that the I/O event is associated with is provided to the application as an opaque handle, file descriptor, or other indirect reference, meaning that such parameters are not provided as pointers to internal implementation structures. For example, for network events, the socket is provided in the form of a descriptor or opaque handle as opposed to a direct pointer to structures such as protocol control blocks. In some embodiments, the system uses this approach and implements a protection boundary between the system and application, and among multiple applications. The system further uses this approach to maintain the independence of internal structures from application implementations.

In some embodiments, the I/O descriptor feature of the event handler API is additionally applied to other I/O events, as well as non-I/O events. The event handler API uses an opaque handle or file descriptor as a parameter and applies this to events such as disk I/O events and file system events, as well as others, all of which may have different internal structures or objects, such as a file object rather than a socket object, associated with the I/O events. The opaque handle or file descriptor can identify any such object, as well as a socket. This is in contrast to using a pointer to a socket or protocol control block that can only be used to identify sockets.

In an alternative embodiment, an application-specified value is used in lieu of the descriptor that identifies the I/O object. In one such embodiment, the event handler API passes information about the socket using the application-specified value or object rather than by using a system-assigned descriptor of the socket. In a system using asynchronous I/O (“AIO”) posting in conjunction with event handler invocation, the application AIO posting in some embodiments has an attached application-specified value or object, where, upon completion of event handler invocation, the application-specified value or object posted with the I/O operation is used to identify the event.

In some embodiments, applications on the host system define and configure which handler to call upon the occurrence of events. The application or system configuration, not the incoming message, identifies the event handler to call on the host. This arrangement enhances security as compared to prior active message systems where the handlers to invoke are specified by the incoming message from the network.

In some embodiments, all necessary event-processing information for an event is provided in event handler API parameters when the system invokes the application handler, and thus no additional calls to individual I/O operations are needed by the application to retrieve information or process the event.

As an example of such an API implementation, upon a network receive event, the event system would invoke the application handler according to an API prototype like the following:

onRecv(socket_descriptor, message, message_size, . . . )

The receiving socket is provided as an opaque handle as discussed previously. Received message content and message size are also provided as parameters. There is no need for the application to call recv( ) either subsequent to receiving the event, or as a prior posting of AIO operation.

In some embodiments, the message content can be provided as a pointer to one or more buffers, arranged in any form, along with the payload size of each buffer. Zero or more additional parameters may also be provided. In one embodiment, protocols are processed by the system before calling the application handlers. In this way, received messages provide only application content to the application. This frees the application from handling protocol headers as compared to conventional message handler API's. Alternatively, if an application requires, lower level protocol headers may be included in the message provided to the application. In one embodiment, applications are not required to have knowledge of buffer management, or to free I/O buffers or wrapper objects of such buffers.

As another example, upon an event requesting a network connection, the system invokes an application event handler using an API prototype like the following:

onAccept(socket_to_be_accepted, listen_socket, . . . )

The socket to be accepted is provided to the application. The listening socket that the connection request is received on can also be provided. The sockets are all provided as opaque handles or descriptors or such indirect reference forms as discussed previously. Zero or more additional parameters may also be provided. There is no need for the application to call accept( ) either subsequent to receiving the event, or as a prior posting of an AIO operation. Implementing the handler without these other operations is sufficient.

Other examples follow the same methods just described. For each type of event or a class of event types, specialized application handler API's are constructed in such a way that all information needed to process the event is provided to the application at invocation of the application event handler. The parameters are provided to the application in a manner that does not require application knowledge of internal data structures used in protocol or stack implementations. In particular, system objects such as sockets, files, etc. are provided as opaque handles or descriptors or other indirect reference forms.

In some embodiments, event handler API's provide multiple events in a single application event handler call following the same methods as described previously. List (e.g. list of sockets), array (e.g. array of messages), hash table, or any other forms and structures of packaging multiple instances of parameters can be utilized. Alternatively, the parameters of one event can be organized in a structure, and a list or array of event structures can be constructed. In some embodiments, the number of events provided in the event handler call is included.

These API's can be used in multiprocessing environments. For example, they can be used not only in direct invocation from the same event system I/O polling and servicing thread that polls for, and discovers, I/O events, but also in event handler invocation in other threads. Other threads may include, for example, application threads, other system threads, or both that operate after events are queued to other processors in both the queuing to application model and queuing to system model discussed previously. There may be one or more threads that poll for I/O events in parallel in the system, and event handlers using these new API's can be invoked from such polling threads in parallel. Other threads may include application threads, system threads, or both. This is in contrast to systems where the callback mechanism and API's can only be used in a single thread that polls for I/O event from the NIC.

The names of the API functions above are by example, as they are prototypes for functions to be supplied by the application. The order, names, or forms of the parameters would thus be determined by the nature of the function supplied. Zero or more parameters in addition to the example or described parameters may be provided. Return values will also depend on the function supplied. Parameters provided need not be a list of parameters, but can take other forms, such as members in a structure.

3.0 Application Polling in Conjunction with an Event Queue and a Fast I/O System

In some embodiments, the event system combines one or more of the following attributes: 1) an event system in conjunction with fast I/O that delivers events to event queues; 2) scalable polling for events from the application irrespective of the number of file descriptors that the application may be interested in; and 3) absence of application prior posting of individual asynchronous I/O operations for event delivery. Conventional systems, in contrast, lack one or more of these elements.

The embodiments described in this section include application polling models where applications poll for events, generally in event processing loops executed by the application. This differs from event-driven models described in section 2 where applications only supply the event handlers to be called. In application polling models, applications supply the polling loops that continuously poll the event queues. The event queues and event discovery and delivery to the event queues are supplied by the system.

The queues discussed in this section are event queues unless otherwise indicated. To qualify as an event queue, first, the queue should be able to receive I/O events. That is, the event system can enqueue I/O events onto such queue. This is distinct from other types of system queues, such as message queues or inter-process communication queues, which in conventional systems are separate from I/O systems and do not have I/O events delivered to them. Second, the queue should be able to receive events from multiple file descriptors. That is, the system can enqueue events associated with multiple different file descriptors onto the same event queue. This is distinct from queues that are internal to a socket or to other file descriptor object implementations. For example, a packet queue or other queue that stores states of a socket is not an event queue, as it belongs to a single file descriptor. As an event queue is a special case of a queue, the variety of ways, structures, and implementations of queues generally are applicable.

In some embodiments, event queues can take events from multiple file descriptors, multiple types, and multiple sources. For example, the event queue may take events of multiple types and sources including, but not limited to, network, block device I/O, file system, inter-process and inter-processor messages. An event queue may be specialized to take delivery of events of a certain type, or a set of types, or a file descriptor, or a set of file descriptors according to the configuration of the application. For example, the application may configure delivery of only one socket's events to an event queue. This, however, is different from the queue being associated with only one file descriptor. Event queues are capable of taking events from multiple file descriptors, and any particular usage is at the discretion of the application. In contrast, queues of a socket object can only take events from one socket. In some embodiments, event queues may take delivery of events originated from multiple I/O devices, possibly mixed types of devices (e.g. network and storage devices). In some embodiments, event queues take delivery of events associated with any file descriptor, any type, and any source.

Event queues are not to be literally regarded as queues that only take events. Event queues as disclosed herein can take the form of other types of queues. For example, the system may deliver an I/O event as a task to a task queue, or combined event and task scheduling queue. The content of queuing in this case can be an event handler or event-processing task that is directly enqueued as a task to be executed. The task queue, or combined event and task scheduling queue, or other equivalents, when they take delivery from the I/O event system, are equivalents of literal event queues. Similarly, the system may deliver an I/O event as a message onto a message queue, or inter-process or inter-processor communication queue. When the message or IPC queue take delivery from the I/O event system, their nature becomes altered and they are no longer the usual message queue that is separate from the I/O systems, but instead, are an event queue in accordance with the meaning used in this disclosure. The content of queuing to an event queue or equivalents does not have to consist of only event objects, but can be other types of objects (e.g. packets or messages), file segments, blocks read from disk or storage, tasks, etc.

One or more of such event queues may be implemented in an event system. For example, applications may configure events associated with one set of descriptors for delivery to event queue A, while events associated with another set of descriptors for delivery to event queue B, and events associated with yet another set of descriptors for delivery to event queue C, and so on. Accordingly, the event system can deliver events to one or more of the event queues.

3.1 Event Queuing System in Conjunction with Fast I/O

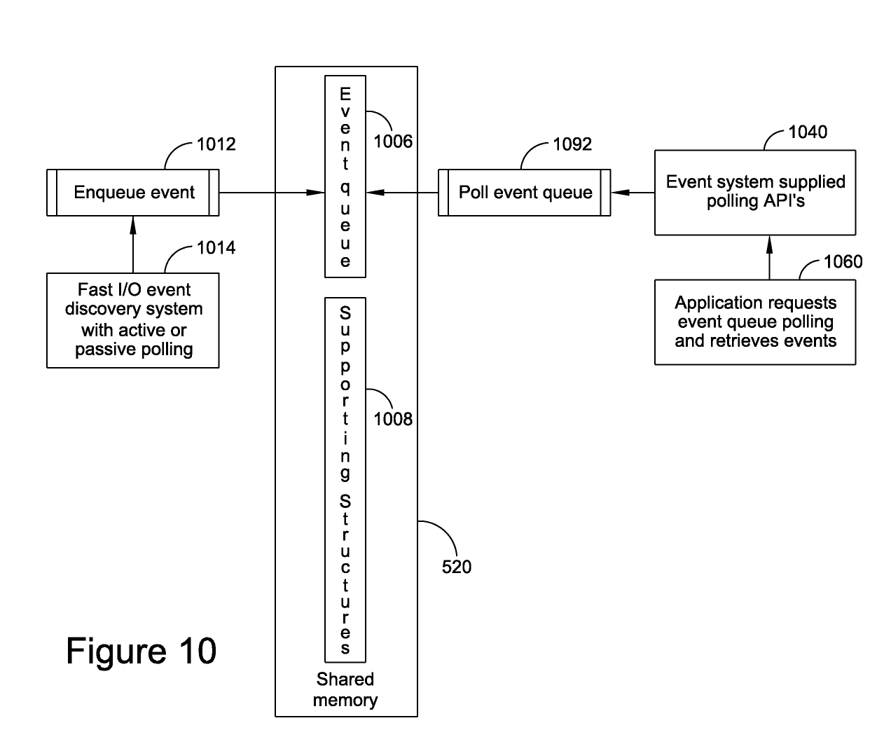

Referring now to FIG. 10, the event queuing system, in accordance with some embodiments, is implemented in conjunction with fast I/O systems 1014. Event system polling mechanisms implemented in conjunction with fast I/O were discussed previously and such discussion incorporated here by reference. Events discovered by the fast I/O event discovery methods and system 1014 are enqueued to the event queue 1006. In some embodiments, the event system polling and I/O servicing threads 210 directly enqueue the I/O events upon the discovery of events through polling I/O devices or virtual interfaces 238. In other embodiments, the event system polls for I/O events passively when the application calls I/O or event polling functions 250. Upon discovery of I/O events through such polling of I/O devices or virtual interfaces, the events are enqueued to event queues 1006. These combinations in conjunction with the delivery from the fast I/O event discovery mechanisms to the event queues eliminates the interrupts and context-switching that are associated with conventional I/O and event delivery paths in traditional operating systems, thus providing improved performance.

In some embodiments employing the passive polling methods 250, the event system implements further event delivery optimizations. For example, when an application polls on an event queue by calling event polling API's 1060, 1040, the underlying implementation polls for I/O events in response. After discovery of I/O events, the event system implementation determines whether the discovered events are destined to the event queue polled by the application, and whether the event queue was empty (i.e. having no prior events that should be delivered to the application first) before the current incoming event. If the event discovered is destined for the event queue polled by the application, and if the event queue was empty, then the discovered event is returned to the application without queuing to the event queue by putting the discovered event directly in the application polling function's return parameters. Otherwise, the event is enqueued to the appropriate event queue.

In either the passive or active I/O polling embodiments, polling of each individual file descriptor is not required. The maximum number of queues polled does not increase linearly with the number of file descriptors. The number of event queues polled by the event system polling API implementation is constant. In some embodiments, the number of I/O device queues or virtual interface queues polled by the underlying implementation does not increase linearly with the number of file descriptors the application is monitoring. More particularly, as the number of descriptors the application registers for delivery to an event queue, or the equivalent event polling method/mechanism increases, the number of I/O queues polled does not increase linearly with the number of descriptors.

In some embodiments, the application polls through system-provided event polling API's 1040. The event system implementation of the event delivery and application polling mechanisms is distinct from traditional operating system event queues. Current operating system mechanisms such as epoll( ) on UNIX, or I/O completion ports in Windows™, were built on a kernel event queue, with application polling context switching to kernel-space to retrieve events. In this embodiment, event delivery does not context switch, as event polling from the application-space does not need to enter kernel-space, but rather, polls on event queues implemented in shared memory 520.

The event system in conjunction with fast I/O event discovery 1014 may be implemented in user-space or in kernel-space. The events discovered by the fast I/O event discovery system 1014 are delivered into the event queues without context switching. In one embodiment, the fast I/O event discovery system 1014 is implemented in the same address-space as the application. In this embodiment, the system, the event queue, and the application are in the same address-space as the application, thus enqueuing and dequeuing occur without context switching.

In some embodiments, the event system in conjunction with fast I/O event discovery 1014 is implemented in user-space, but in different address-space from the application. In another embodiment, the event system in conjunction with the fast I/O event discovery system 1014 is implemented in kernel-space. In both of these embodiments where the event system in conjunction with fast I/O event discovery do not live in same address-space as the application, shared memory 520 can be used to communicate with the application-space. Shared memory 520 is mapped to both the system address-space and the application address-space. This applies whether the event system in conjunction with fast I/O event discovery lives in user-space or in kernel-space. The event queues 1006 and all related support structures 1008 reside in shared memory 520. Thus, both the application and the event system have direct access to the queuing structures. Event objects (i.e. the content of enqueue) can also be allocated from the shared memory 520. Enqueuing from system-space to the event queue 1006 is accomplished through shared memory access, without context switching. Similarly, the application polling API implementation (i.e. the dequeue or retrieve function) 1040 is accomplished through the shared memory access, without context switching.

Shared memory alone offers minimal benefit over conventional operating system event systems. It is the combination with a fast I/O event discovery system 1014 that results in significant benefits. For example, event queues with shared memory structure have been implemented on top of, and integrated with, conventional operating system networking and I/O stack. Such event systems do not provide significant benefit over traditional event queue mechanisms such as epoll( ) using just a kernel queue without shared memory.

3.2 Scalable Polling for Events from Application-Space

Event polling by applications, in accordance with some embodiments, is scalable irrespective of the number of file descriptors that the application may be interested in. In some embodiments, the events from multiple file descriptors are delivered to the same the event queue. Upon application polling, events are dequeued from the queue, irrespective of how many file descriptors there are. This is in contrast to methods that poll file descriptors.

Prior kernel-bypass fast network systems polled on each of the file descriptors and checked the state of each of the underlying I/O objects implementing the descriptors. As the number of descriptors an application monitored increased, the level of polling (e.g. the number of queues polled by the system) increased linearly with the number of descriptors. As a result, such polling models were not scalable across an increasing number of file descriptors. For example, in prior methods that implement epoll( ) API on top of fast networking, the underlying implementation was done by polling on lists of file descriptors, in other words, by polling the state of each of the underlying I/O objects implementing the descriptors. Such implementations were equivalent to poll( )-like API functions, the only difference being in the facade itself. Where a poll( ) call would give the set of file descriptors in the polling call, the epoll( ) interface would register the set of file descriptors prior to the polling call with control calls such as epoll_ctl( ). In the underlying architecture of prior system, each epoll( ) polling function invocation polled on the entire list of descriptors registered. Even with the epoll( ) facade, the underlying implementations were not scalable with increasing number of file descriptors.

The event queue model implemented in some embodiments of this invention do not poll file descriptors. Instead, events are queued to, and dequeued from, the event queue using an event-based approach. The central activity is the dequeuing of events rather than the polling of file descriptors. An event queue collects all the events associated with multiple descriptors. The collection of events is accomplished by the following mechanism:
a) implementing the event queue being outside of file descriptor objects such as socket objects;
b) enqueuing the events onto the event queue as they are discovered; and
c) allowing events associated with different file descriptors to be enqueued on the same event queue.
   Events are dequeued from the event queue at the time applications poll for events. No polling of the individual underlying I/O objects implementing descriptors occurs, and thus the number of queues polled does not increase in relation to the number of descriptors.

3.3 No Application Prior Posting of Individual Asynchronous I/O Operations

In some embodiments, the event system does not require applications to perform prior posting of individual asynchronous I/O operations for event delivery. This is in contrast to AIO-like completion event models. In completion event models like AIO, the application must first post I/O operations by calling the asynchronous version of the I/O operation API, for example aio_read( ), aio_write( ), or send( ) and recv( ) equivalents of such calls. Events are delivered after I/O operations have been posted, and generally as completion events for the posted I/O operations. Completion models and programming interfaces like AIO work in this manner, regardless of where the binding to the completion queue occurs. For example, the event queue for event delivery was provided and bound at every AIO call. Alternatively, binding to the event queue occurred at the work queue or queue pair level (i.e. work queues to completion event queue binding). Regardless of where the binding occurred, these approaches all required individual asynchronous I/O operations to be posted before completion events could be delivered.

In contrast, the event queue model according to one embodiment does not require the application to perform prior posting of individual I/O operations. The application configures the delivery through the queue system once, and the events are delivered as they arrive without application prior posting of individual I/O operations. The system provides API's and other facilities for applications to configure event delivery to event queues. For example, the system can provide configuration API's where applications can specify the events of a file descriptor to be delivered to an event queue of the event queue system. After one such configuration call, all future events of that file descriptor are delivered to that event queue. Once configured, the system will deliver subsequent events upon events occurrences, rather than require an application to perform individual I/O operation postings. Information such as destination of queuing are configured by the application, and can be set for a file descriptor or set of file descriptors, for a type or set of types, for virtual interfaces, queue pairs, work queues, etc., at a level that is higher than individual I/O operation, and in any combination thereof. More sophisticated rules, wild-cards, predicates, filters, etc. may be used in conjunction with the basic configuration. In an alternate embodiment, the configuration is provided through configuration files or scripts. For all varieties of configuration methods, prior posting of asynchronous I/O operations are not required for event delivery.

4.0 Event Queuing Methods and Systems

In some embodiments, the event queuing system includes an event queue or equivalent structure, to which, an application enqueues application-specific events or messages. Event queue definition and variations of features, embodiments, as well as wide variety of implementations are described in section 3.0, and included here by reference. This system further provides methods that allow applications to enqueue application-specific events or messages onto the same queues, to which, the system delivers I/O events. In the event queuing system according to this embodiment, both the I/O system and the applications can be sources of events.

One traditional event queue system is the I/O completion port implementation in Windows™, which is distinct among such traditional operating system facilities, as it allows applications to enqueue events. Such traditional systems were implemented on top of, and integrated with, traditional operating system networking and I/O stacks. In addition, in traditional systems, application's enqueuing and dequeuing of events involves context switching.

In some embodiments, the event queuing system is implemented in conjunction with fast I/O and event discovery mechanisms described prior and incorporated here by reference. This eliminates the overhead associated with interrupt and context-switching in traditional I/O and event system architecture. In some embodiments, the event queuing system uses shared memory and further eliminates context-switching associated with enqueuing and dequeung of events.

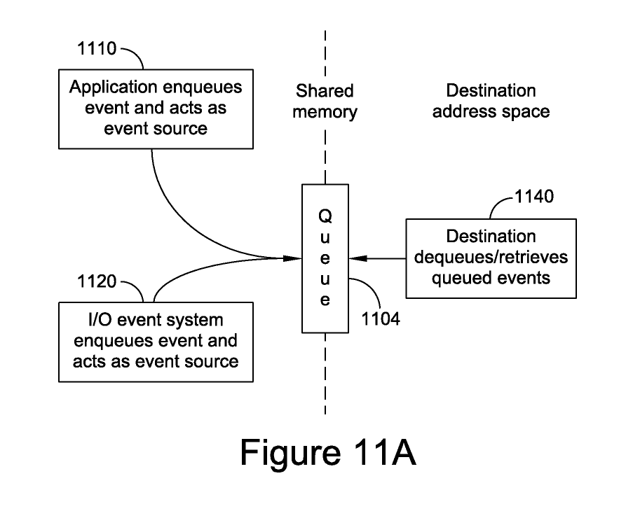

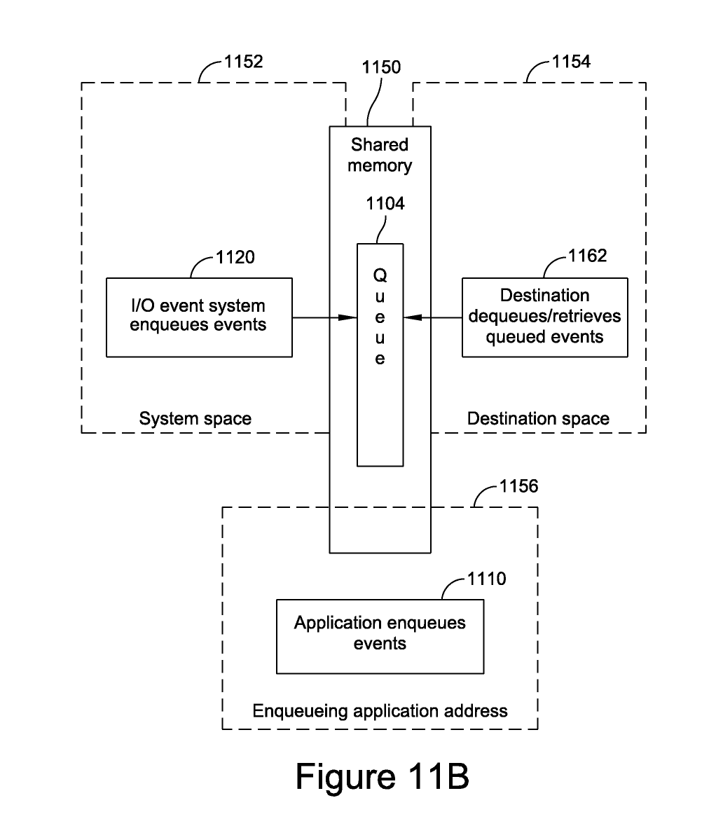

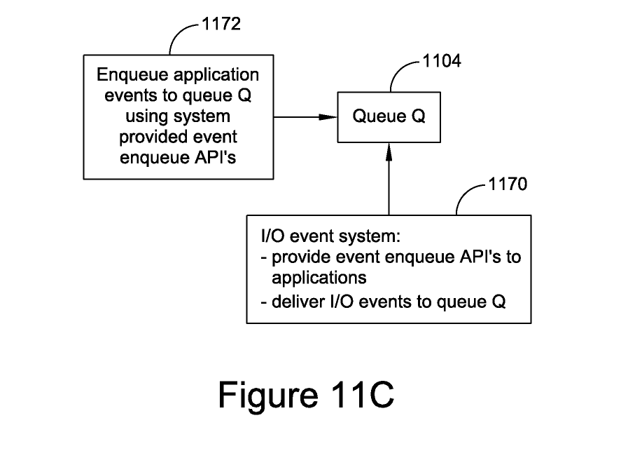

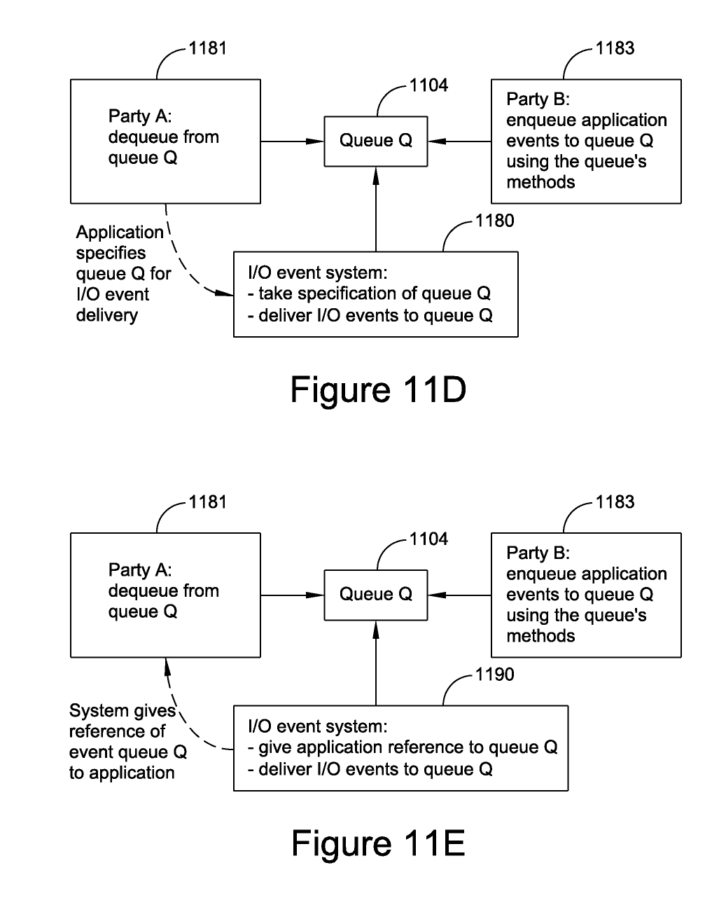

Referring now to FIG. 11A, in some embodiments, a queuing system includes both an I/O event source 1120 and an application event source 1110. The I/O event system enqueues events to the event queue 1104, and thus acts as an event source 1120. Applications also enqueue events to the event queue 1104, and thus acts as an additional event source 1110. The event queue 1104 can take events from at least both of these sources 1110, 1120. The destination thread can poll the same event queue, and retrieve events from both the I/O and application sources 1140.

In various embodiments, event content is provided by applications in a variety of forms. In some of these embodiments, the application can enqueue and dequeue arbitrary application-specific objects. In some of these embodiments, event content provided by applications is dissimilar to I/O event content (e.g. the file descriptor that the I/O event is associated with, the number of bytes of the transfer or network message, etc.), and can be any application content. Thus the event queuing system can be used for general-purpose, inter-process and inter-processor communication

4.1 Event Queuing Systems in Conjunction with Fast I/O

In some embodiments, the event queuing system is implemented in conjunction with fast I/O and event discovery systems. Event systems implemented in conjunction with fast I/O systems are described in detail in section 1 and included here by reference. I/O event discovery and the underlying I/O can be implemented in any of the various embodiments described previously. For example, event discovery and I/O methods may be accomplished through active polling methods or passive polling methods. Polling may be conducted through virtual interfaces or through direct I/O devices and device driver access. In the case of active methods where there are one or more system polling and I/O servicing threads continuously polling for I/O events, the system polling and I/O servicing threads may be pinned or otherwise run on dedicated processors. All these and various methods are described in detail in section 1.

Following event discovery, the events are delivered to the application, whether through queuing or invocation of the application event handlers. In these embodiments, event delivery methods are implemented in conjunction with the delivery of I/O events to dual-use queues where applications can enqueue application events in addition to the queued I/O events. The application can then use the same methods for processing both I/O events and inter-process or inter-processor communication.

In one embodiment, an application uses the event-driven methods described in section 2 to process I/O events and inter-process or inter-processor communication. I/O events, as well as inter-process and inter-processor communication events from application sources are all enqueued onto the same event queue. An event system supplied destination polling thread 424 polls for events from the event queue. Upon retrieval of events, the polling thread calls the appropriate application event handler. The retrieved event may be an I/O event, in which case the application event handler registered for the I/O event will be called. The retrieved event can be an inter-process or inter-processor communication, in which case the application event handler registered for the application-specific communication will be called. The application can use a uniform set of methods and supply event handlers to be executed on desired processors or threads, thus handling all events as opposed to having to use disparate systems and methods, as was the case in conventional systems.

In another embodiment, applications use the application polling methods described in section 3 to process I/O events and inter-process or inter-processor communications. Both I/O events and inter-process or inter-processor communication events from application sources are enqueued onto the same event queue. In this case, applications poll the event queue for events. The retrieved event may be an I/O event, or an inter-process or inter-processor communication. The application can use the same event polling-loop thread to handle all events, as opposed to having to use disparate systems and methods as was the case in conventional systems.

4.2 Shared Memory Enqueuing and Dequeuing Without Context Switching

In one embodiment, the destination is in the same address-space as the enqueue application thread. This occurs, for example, when one thread of an application wants to communicate to another thread of that same application. In another embodiment, the destination of the queuing operation is another application that lives in a different address-space from the enqueue application. In yet another embodiment, the destination of the queuing operation is part of the system that lives in system address-space. For example, an application may want to send a message to the system, or to an application event handler or task running on a system thread.

In various embodiments that implement the event queuing system, event enqueuing and dequeuing by applications occurs without context switching. When the destination of the queuing operation lives in the same address-space as the enqueue application, event delivery occurs without context switching by virtue of living in the same address-space. When the destination of the queuing operation lives in a different address-space from the application, whether in user-space or kernel-space, shared memory is used to achieve event delivery without context switching. Shared memory is mapped to both the enqueuing application's address-space and the destination address-space. The shared memory region mapped includes at least the event queue, and may include some or all supporting structures for the enqueuing and retrieval of events. In some embodiments, supporting structures include event objects to be enqueued and allocated from the shared memory space. Both the enqueueing application and the destination can have direct access to the event queue using shared memory. Thus, both the enqueue operation from the enqueueing application, and the event retrieval operation from the destination occurs without context switching. Thus, it can be said that event delivery to a destination occurs without context switching.

With respect to FIG. 11A, since both the application and the I/O event system can be a source of events, there can be multiple delivery routes to the same event queue and destination. There is a distinct delivery route from the application event source as described previously. Shared memory is also used as a method of event delivery from the I/O event system source. Shared memory embodiments of event queues and event delivery from the I/O event system to the application are described both in section 2 and section 3 for the event-driven model and application polling model respectively, and are included here by reference.

Referring now to FIG. 11B, in some embodiments, shared memory consists of a three-way mapping. First, memory is mapped into the inter-process or inter-processor event source application's address-space 1156. Another mapping of the shared memory is made into the fast I/O event polling and discovery system's address-space 1152. Finally, another mapping of the shared memory is made into the destination application's address-space 1154. In some embodiments, the shared memory 1150 may be native to one of the above address-spaces, thus no mmap( ) or equivalent call is needed to access the memory, and thus two actual mapping operations are performed to form the three-way mapping arrangement.

In some embodiments, one or more of each of the above address spaces may exist in a system. The shared-memory mapping in these cases is an n-way mapping. Event delivery methods of the I/O event system are independent of the shared memory mechanism for enqueuing application events.

In some embodiments, the same event queue 1104 is accessible from multiple routes, whether such routes are from the enqueuing application or from the I/O event system, and thus this same event queue 1104 can be used by the destination application for monitoring of both I/O events as well as inter-processor and inter-process events 1162.

4.3 Application Event Queuing API and Methods

Various embodiments that implement the event queuing system provide event queuing API's for applications to enqueue their events onto the event queues. Referring now to FIG. 11C, in some embodiments, applications specify the event queues 1104 to deliver the application events to using these API's 1172. A queue may be specified in the form of an opaque handle, file descriptor, or other form of indirect reference to the queue. Alternatively, the queue objects can be referenced directly using a pointer or other direct reference.

In some other embodiments, instead of specifying queues, applications specify the threads or processors to deliver the application events to using the API. For example, if the application wants to communicate to another thread running on different processors within the same process address-space, the application can specify the target destination processor ID or thread ID. The enqueued application event will be delivered to an event queue associated with the destination processor or thread. One or more threads or processors may be associated with an event queue. The destination thread on the target processor will poll the event queue and retrieve the inter-processor communication. In some embodiments, applications may specify the process in addition to event queue or processor information. For example, if the event queue or processor information implemented in the system does not already include process information, when enqueuing to a different process or address-space, the system-provided event enqueue API 1170 may have additional parameters to specify the destination process for delivery of the application event. In various embodiments, the API's may allow the application to specify queues, processors, threads, or processes to deliver the events to, and in any form, including, for example, pointers or direct references to the queues, id's, handles, descriptors, or other forms of indirect references.

The event queuing API can also allow applications to provide event content, which can take a variety of forms, from members in event structures to lists of parameters of event content, and in any combination thereof. There may be many forms of API's or API sets that allow applications to specify the event or multiple events to deliver to the queue or multiple queues, processor or multiple processors, thread or multiple threads, process or multiple processes, and in any combination thereof. Applications, systems, or both may poll for events on such event queues, and thus receive one or more application-generated and queued events, I/O events, and other queued items.

In various embodiments, the event queuing API implementation supports concurrent multi-processor and multi-entity access to the event queuing system. Such concurrent access can be achieved by implementing any of a variety of standard methods including concurrent data structures, locking, separate per-processor queues, and any other methods or combination of methods that allow multiple parties to enqueue or dequeue concurrently.

In various alternative embodiments, instead of using event queuing API's provided by the event system, applications use API's and methods associated with queue objects to enqueue events. For example, if the queue is a concurrent queue object, an enqueue method associated with the concurrent queue can be used rather than the event queuing API. Applications can also use API's and methods associated with the queue objects to dequeue events rather than use the event polling API's provided by the event system. In these embodiments, the event queuing occurs through calls to the API's of the queue object itself. As a result, the system does not need to provide the event queuing API described above.

In one example of an alternative embodiment, applications specify a queue as an event queue. Applications then invoke methods of the queue to enqueue events. For example, referring to FIG. 11D, an application A creates a queue Q 1104, and specifies it as an event queue for delivery of I/O events 1181. In this case, the application has reference to the queue Q. The system provides functionality to register the queue Q for I/O event delivery, and thus the queue Q is now an event queue 1180. When application event source B enqueues events for delivery to A 1183, B can use the methods of queue Q to enqueue events onto the queue Q.

In another example of an alternative embodiment, the system provides applications with references to system-provided event queues. Referring to FIG. 11E, the system-provided functionality gives the reference of the event queue Q 1104 to the application 1190. When the application event source B enqueues events for delivery to A 1183, B can use the method of queue Q to enqueue events. In both of the examples, it is not necessary for the system to provide the event queuing API, but instead, provides other functionality. For example, the system allows applications to specify the queue to be used as the event queue for I/O events, or provides applications with an event queue reference, achieving the same objective of allowing application to enqueue events onto dual-use queues that handle both application events and I/O events.

In some embodiments, the system provides event queuing API's in conjunction with one or more of the above facilities, thus allowing applications to use both the event queuing API and the queue object API to enqueue and dequeue.

4.2 Event Queuing Methods Applicable to Traditional I/O

The event queuing methods disclosed previously, including the shared memory enqueue and dequeue methods that occur without context switching and the event queuing API methods, can be applied to traditional operating systems and I/O architectures. The memory region that includes the event queue is mapped into the application space of both the enqueuing and dequeuing applications. Some features of the event queuing API, for example, allowing applications to specify specific threads or processors for event enqueuing, can be added to traditional operating systems. The methods for providing applications enqueue capabilities through queue-related API's can be implemented in conjunction with traditional operating systems, thus enhancing the flexibility of the system in a manner similar to that of the embodiment using fast I/O previously described.

5.0 Event Distribution and Event Filtering

In some embodiments, event system mechanisms distribute events to multiple destinations. Event systems as related to the subject matter of event distribution in this invention in particular, when implemented on the host computer as opposed to inside peripheral hardware such as in a NIC, are more applicable to general-purpose applications. Event distribution features on host computers provide applications with powerful control of parallel processing on processor cores of the CPU's, especially in light of advanced microprocessor technology implemented in multi-core CPU's. Event distribution implemented on the host computer, along with the many facilities of the event system as well as the overall host computer programming environment can be of more use to applications than distribution features implemented inside peripheral hardware. In contrast, distribution features inside peripheral hardware stop at the device queue level. Applications running on the host computer, generally do not have access to device queues but go through operating system services, and thus are still limited by the slow traditional I/O and event system. Some of these embodiments remove the performance barrier for applications by providing a fast and scalable event system implemented on the host system that is directly accessible by applications running those systems.

In some embodiments, the destinations of event distribution are event queues or equivalents. To qualify as an event queue, the queue should be able to take events from multiple file descriptors. That is, the system can enqueue events associated with multiple different file descriptors onto the same event queue. This is distinct from queues that are internal to a socket (or other file descriptor object) implementation, such as a packet queue or other queue that store states that belongs to a single file-descriptor. Equivalents of event queues, such as schedule or task queues may also be used. Such equivalents are not internal to, or only associated with, a single file descriptor object, such as a socket, and an equivalent system implementation may choose to enqueue event handler functions as tasks onto task or schedule queues. Event queue and equivalents are described in detail in section 3, and incorporated here by reference.

In some embodiments, the event system delivers the events upon event arrival, without requiring application prior posting of asynchronous I/O operations. The application configures the event distribution to the multiple destinations once, and the events are delivered to the multiple destinations as they arrive without prior posting of individual I/O operations by the application. The system provides API's and other facilities for applications to configure event distribution to multiple destinations. Examples of event distribution configuration are described later in section 5 and are incorporated here by reference. Once configured, the system will deliver subsequent events upon events occurrences, rather than require an application to perform individual I/O operation postings. This is in contrast to prior designs using the completion queue event model. In the post-and-complete event model, applications had to post asynchronous I/O operations first, before completion events for the prior posted I/O operations could be delivered. The posting of I/O operations were generally at the individual I/O operations levels, for example, when application call recv( ) or equivalent APIs such as aio_read( ). Event delivery had to wait for application posting. In addition, when the event queue was also specified at the individual I/O posting level, the event queue for event delivery had to be bound at each and every I/O operation call. Even though such system could theoretically deliver events to multiple event queues, for example by giving different event queues in each different I/O operation posting call, the event system would be very inefficient because of the overhead of posting every individual I/O operations and binding event queue at every individual I/O operation posting.

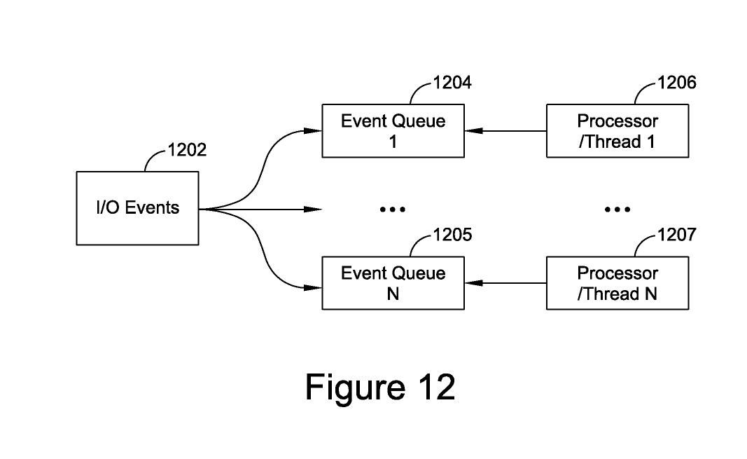

In some embodiments, the events are distributed such that each of the multiple event queues receives a subset of the events. One advantage of this mode of event distribution is to scale the event processing on multiple processors, where each processor process a portion of the total number of events, and the whole event stream is processed much faster as a result of multiple processors processing concurrently in parallel. Referring now to FIG. 12, in some embodiments, the event system distributes incoming events 1202 to a plurality of queues 1204, 1205, where each queue receives a subset of these events. Associated processors or threads 1206, 1207 for a particular queue process the events or tasks in that queue. Thus, the events are distributed to and processed by multiple processors in parallel. This mode of distribution is referred to as the “scaling distribution” mode.

In some embodiments, the events are distributed such that each of the events is sent to multiple event queues. For example, when the system receives an event E, this event E is sent to multiple event queues, for example, event queue Q1 and Q2. When processor P1 polls Q1, P1 retrieves and processes the event E. When processor P2 polls Q2, P2 also retrieves and processes the event E. In this case, the whole stream of events is not be processed faster by P1 and P2 acting concurrently in parallel. Instead, P1 and P2 each process the same events. This mode of distribution is referred to as “duplicate distribution”. This mode of distribution offers applications flexibility in processing methods. For example, applications can use several different application algorithms to process the same set of events. The application can use this mode of distribution to process the same events on several different threads or processors, each running a different algorithm.

The different modes of event distribution can be combined. For example, an event system can implement both of the above example modes of event distribution, and the application can choose one or more modes to use for a particular set of events upon application configuration of event distribution. For example, an application may choose to use the scaling mode of distribution on one set of events, where each event queue receives a subset of the total number of events. On another set of events, the application may choose to send the same events to multiple queues where it can process these same events using different application algorithms.

In each of these modes of distribution, the objects of distribution can be I/O events or other types of objects (e.g. packets, messages, file segments, blocks read from disk or storage, tasks, or other objects). In some cases, the destinations specified by the application when configuring event distribution may not be event queues or equivalent queues, but instead, may be other objects, for example, processors, threads, and processes. In such cases, the event system will choose the event queues or equivalents associated with the destinations. Event distribution configuration is further described later in section 5.

5.1 Event Distribution in Conjunction with Fast I/O

Event systems implemented in conjunction with fast I/O have been described in section 1 and are included here by reference. In addition, the event system implements and offers applications the choice of using multiple event queues. After event discovery according to one of the described methods in conjunction with fast I/O, the system distributes the events to multiple event queues. In one embodiment, the event system employs an I/O event polling thread 410 that continuously polls for I/O events and enqueues the events to the appropriate event queues upon event discovery.

In some embodiment, upon discovery of an event, the event system selects one queue from a plurality of event queues to enqueue the discovered event according to the application configuration and distribution method. Each event goes to one queue, and each of the multiple event queues and destination processors receive a subset of the events. The entire stream of events is processed faster by multiple processors acting in parallel, thus scaling distribution.

In some other embodiments, upon discovery of an event, the system enqueues the discovered event to multiple event queues according to the application configuration and distribution method. Each event goes to multiple queues and is in turn processed by multiple threads, possibly each running a different algorithm and thus achieving duplicate distribution. An event system may include one or more, or any combination of, these event distribution modes.

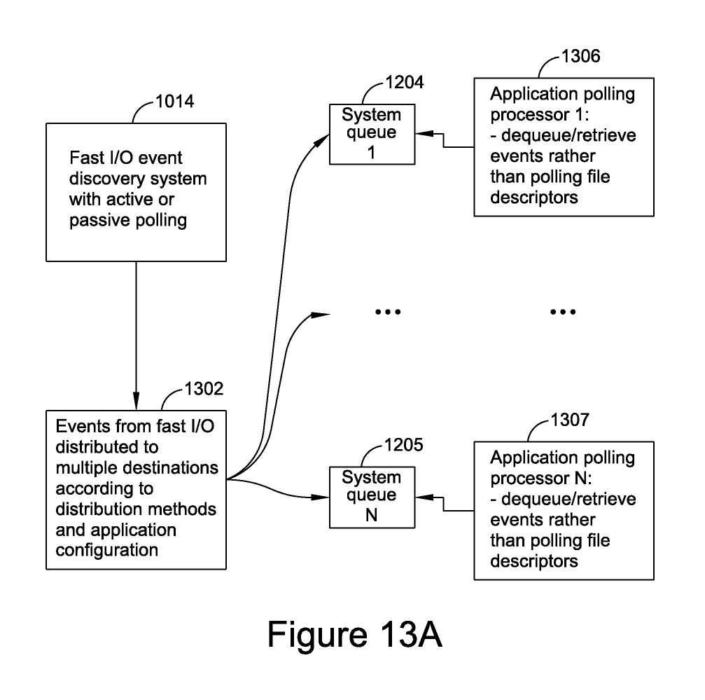

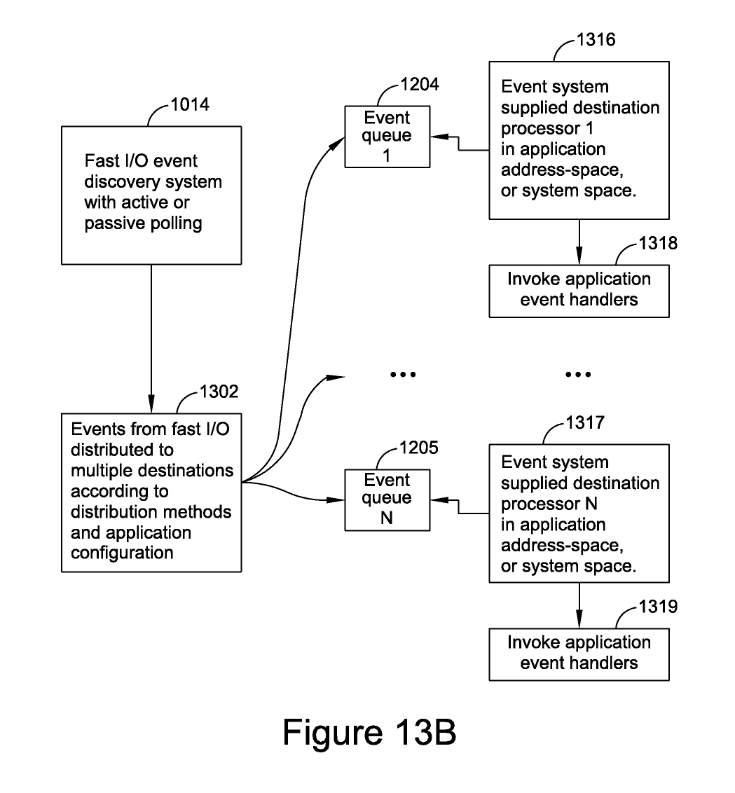

Referring now to FIG. 13A, in some embodiments, event distribution mechanisms are combined with the event polling model of event processing. The event polling model and mechanisms are described in detail in section 3 and incorporated here by reference. Events discovered by fast I/O event polling and discovery mechanisms 1014 are distributed on to multiple event queues 1302. These multiple event queues 1204, 1205 are polled by application threads running on different processors 1306, 1307. The application threads or processors poll and retrieve the queued events in parallel, and thus effect event processing in parallel.

In some embodiments, event distribution mechanisms are combined with the event-driven model of event processing. The event-driven model and mechanisms are described in detail in section 2 and incorporated here by reference. Referring now to FIG. 13B, for example, events discovered from fast I/O event polling and discovery mechanisms 1014 are distributed on to multiple event queues 1302. These multiple event queues 1204, 1205 are in turn polled by system-supplied polling threads at the destinations running on different processors 1316, 1317. These threads or processors poll and retrieve the queued events and in turn invoke application event handlers in parallel 1318, 1319, and thus effect event processing in parallel. These system-supplied polling threads at the destinations that poll on the event queues may execute in either the application address-space or the system address-space. When combined with the event-driven mechanism with queuing to application, described in section 2.1.1, the system-supplied polling threads at the destinations that poll on the event queue reside in application address-space. When combined with the event-driven mechanism with queuing to system, described in section 2.1.2, the system-supplied polling threads at the destinations that poll on the event queue reside in system address-space.

Event-driven mechanism with direct invocation methods, as described in section 2.1.3, can also be implemented in conjunction with event distribution. In some embodiments of this combination, instead of distributing to multiple event queues, hardware IPC mechanisms are used to distribute the execution of application event handlers onto multiple processors. The event handlers are executed in parallel on multiple processors, and thus effect event processing in parallel. Hardware IPC mechanisms that invoke application event handlers as tasks are described in section 2.1.3.1 and in section 8, and are incorporated here by reference.

5.2 Configuration of Event Distribution

In some embodiments of the event system, applications configure the distribution functionality through system-provided configuration API's. In some embodiments, one or more file-descriptor object's events may be configured for distribution to a set of destinations. The file-descriptors, for example, may be sockets, files, block devices and storage, or any combination thereof. In some embodiments, one or more types of events may be configured for distribution to a set of destinations. Further, any combination of one or more file-descriptors and types of events may be configured for distribution to a set of destinations. For example, the various embodiments of configuration can provide the following mappings:
a) File-descriptors to destinations mapping:
[file-descriptor, set of destinations]
In this example, events of a file-descriptor object (e.g. a socket), are distributed to the set of destinations.
[set of file-descriptors, set of destinations]
In this example, events of multiple file-descriptor objects (e.g. a set of sockets), are distributed to the set of destinations;
b) File-descriptors in conjunction with event-types to destinations mapping. The ability to configure type-specific distribution provides additional control of multiprocessing operations. Application may configure different types of events of a descriptor object for delivery to one or more different destinations.
[file-descriptor, event-type, set of destinations]
In this example, a type of event of a file-descriptor object (e.g. receive events of a socket), is distributed to the set of destinations. For example, the application may configure receive events of a socket for distribution to multiple destinations, while configure connections accept events of the socket to be sent to another destination.
[set of file-descriptors, event-type, set of destinations]
In this example, a type of event of multiple file-descriptor objects is distributed to the set of destinations.
[file-descriptor, set of event-types, set of destinations]
In this example, multiple types of events of a file-descriptor object are distributed to the set of destinations.
[set of file-descriptors, set of event-types, set of destinations]
In this example, multiple types of events of multiple file-descriptor objects are distributed to the set of destinations; and
c) Event-types to destinations mapping independent of file-descriptor:
[event-type, set of destinations]
In this example, a type of event independent of file-descriptor is distributed to the set of destinations. For example, all receive events of an application are distributed to the set of destinations, irrespective of the socket.
[set of event-types, set of destinations]
In this example, multiple types of events independent of file-descriptor are distributed to the set of destinations.

The set of destinations may be one or more event queues, processors, threads, or processes, or any combination thereof. In the cases where destinations of the configuration are not event queues, for example, processors, threads, or processes, the system will select the appropriate event queues associated with the destination processors, threads, or process. The association of processors, threads, or process to event queues may vary widely depending on implementation. For example, the processors, threads, or process may poll on the associated event queues. One event queue may be associated with one thread or processor. In this case, when the configuration specifies a processor as one of the destinations for distribution, the event system selects the one associated event queue for that thread or processor. One event queue may be associated with multiple threads or processors (e.g. P1 and P2) which both poll on the event queue Q1. When the specified destinations include P1, P2, and another processor P3 that is associated with Q2, the event system selects event queues Q1 and Q2 for distribution of the events.

Thus, as above described, applications can configure the distribution of events to a specific set of event queues, processors or threads. This provides applications with fine-grained control over multiprocessing operations. In some embodiments, in addition to the above basic configurations, more sophisticated rules, wild-cards, predicates, filters, etc. are used for configuration.

In some embodiments, configuration information is provided as parameters to configuration functions. In another embodiment, configuration information is provided as members in structures that are then provided as parameters to configuration functions. API's can be system functions that are called from application programs. Alternatively, initialization files, configuration files, or scripts, all of which can include equivalent functions, may provide the configurations.

In some embodiments, configuration semantics include one or more configuration functions such as add, delete, set or replace, and modify. For example, when a first application configuration maps a set of destinations D1 to socket A, events of socket A will be distributed to the set of destinations D1. If a next configuration also specifies socket A with a different set of destinations D2, the system may offer one or more of the following semantics:

a) Add

In this case, the system adds D2 to the set of distribution destinations, and thus events of socket A will now be distributed to D1+D2. If the system also offers merge in conjunction with add semantics, the set of destinations D1 can overlap with the set of destinations D2, and the system will merge the two sets of destinations.

b) Set or Replace

In this case, the binding with this latest configuration succeeds, and the system will change the event distribution destinations for socket A to D2.

In some embodiments, the configuration of multiple distribution destinations can be accomplished by using add semantics in conjunction with single destination mapping. For example, for the first configuration, one destination is given, and for a second configuration with add semantics, the second destination is given, and so on. The total set of destinations can be cumulative based on multiple configurations. Delete, modify, and other semantics for configuration may be provided by the system. In some of these embodiments, the system implements multiple such semantics, and applications can specify which are applied in a particular configuration.

In various embodiments, the binding of destinations occurs at a higher level than individual I/O operation posting. For example, mapping at the levels of file-descriptors and event types are above individual I/O operation posting. Such configuration may also be set at other equivalent levels that are higher than individual I/O operation posting. Setting destination configuration at this higher level, in conjunction with event delivery including event distribution, without application prior posting of I/O operations, results in system efficiency.

In some embodiments, the configuration is explicit, meaning the binding of destinations is not dependent or limited by the threads calling the configuration functions, and hence any thread can configure the delivery of events to any destination, including self and any other destinations. This explicit configuration is in contrast to the implicit configuration in traditional operating system. In some traditional event systems, when a thread called the configuration function to declare interest on a file-descriptor object, the calling thread was added to the list of destinations where the events associated with that file-descriptor would be delivered. The traditional event system provided no other way for an application to specify distribution destinations. This form of configuration only allowed the addition of self for event delivery, and was limiting. In contrast, with some embodiments of this invention, applications can provide any set of distribution destinations with calls from any application thread. Explicit configuration can be provided by supplying API's implementing the configuration functions described above in this section, where the event distribution destinations are explicitly given in API parameters, a configuration file, or equivalents, without limiting the event distribution destination specified in an API call to the caller thread alone.

5.3 Additional Event Distribution Features

In some embodiments, one type of event of a file-descriptor I/O object can be distributed to multiple destinations. Referring now to FIG. 14, for example, applications can configure the distribution of all receive events of a socket 1450 to multiple destinations. The system then distributes the receive events to multiple event queues 1204, 1205 which may in turn be polled by multiple processors 1206, 1207 that process the events concurrently. This capability provides for parallel processing of the receive events. Applications may, for example, additionally configure the distribution of other types of events of the socket to go to another event queue 1418 potentially different from the event queues where receive events are distributed, and which may in turn be polled by a different processor 1419. This is distinct from the mere splitting of events of a socket by type, where all receive events go to one queue, and all connection accept events go to another queue. In such splitting by event type, one type of event is only sent to a single queue, something that is not beneficial to the multiprocessing of one type of event. By contrast, distribution of one type of event of a single file descriptor to multiple event queues, processors or threads provide benefits for concurrent processing of that type of event on multiple processors.

5.4 Methods of Event Distribution

Conventional event systems lack distribution methods that can scale the event processing activity. For example, one way traditional event systems selected threads was by selecting the first eligible thread among all threads that declared interest, for example, the first thread sitting in the wait queue waiting for events. This method only worked well in the heavily context-switched environment of traditional operating systems, and did not scale processing in concurrent environments where multiple processors acted in parallel. Yet another approach found in traditional event systems was to send every event to all threads that declared interest. If M threads were in the system and declared interest, each of the events would be processed M times. A set of N events would be processed N×M times, rather than processed faster given multiple processors. This served only to duplicate the processing.

In contrast, the event distribution methods dislosed herein act to scale the processing to multiple processors. In some embodiments, these distribution methods are used in conjunction with the scaling distribution mode, where each of the multiple destinations receive a subset of the events, and the multiple destinations, such as threads, that run on multiple processors poll the event queues and process the events concurrently in parallel, thus whole sets of events can be processed much more quickly given multiple processors.

5.4.1 Round-robin Distribution Method

In some embodiments, the event system uses a round-robin method to distribute the events to the set of multiple destinations. Referring now to FIG. 15A, in one of these embodiments, the event system selects a first destination for delivery of a first event 1502. The first destination is selected based on a destination algorithm 1504. This algorithm may include selecting from a list of destinations (e.g. selecting the first or any predetermined one of a list of destinations), selecting a destination at random, or selecting a destination based on some other criteria. The system stores the selection, for example, by storing, in a variable 1506, the position or the index of the destination selected among the list of destinations. The stored variable is a variable that remains accessible across multiple executions of the destination selection algorithm.

As an example, let I=the stored variable representing the index of last selection among the list of destinations. When a second event arrives 1508, the event system selects the next destination based on the stored prior destination selection 1510. For example, if the stored variable is the index of the last selection in the list of destinations, the next selection increments the index such that I=I+1. The system stores the latest selection in the same variable replacing the old selection. With the arrival of each subsequent event, destination selection follows this same method and selects the next index in the list. When the variable that stores the selection reaches the end of the list of destinations, the next selection wraps around to be the first index in the list of destinations. Thus, the basic round-robin method distributes the events evenly among the list of destinations without having to retrieve and analyze load information. Variations of the basic round-robin method can be implemented that achieve similar results.

In some embodiments, the basic round-robin method is augmented with processor location and communication cost information 1512. When the destination processor is located on the same processor package as the event system thread enqueuing or delivering the event, the communication costs are potentially low. If on the other hand, the destination processor is located on a different processor package (e.g. cross CPU-socket in a multi-CPU-socket machine or NUMA machine), the communication costs are potentially high. In some embodiments, the event system implements an augmented round-robin method where the destinations with lower communication costs are selected more frequently than the destinations with higher communication costs 1512. For example, for every 1 event distributed to a destination with higher communication costs, there can be N (N>1) events distributed to a destination with lower communication costs. The choice of N can be, for example, proportional to the estimation of the relative communication costs.

In some embodiments, the round-robin method is combined with distribution methods that retrieve and consult load information 1514, as described in section 5.4.2. For example, round-robin selection methods select among processors having lower communication costs. Load information is retrieved. When the load on the selected processor exceeds certain thresholds, the selection method is instead based on load information as, for example, described in section 5.4.2. When based on load information, the selection of processors can include both those having low and high costs of communication.

In some embodiments, the selection of the distribution destination using the round-robin method is augmented with cache-affinity analysis 1516. Methods analyzing cache-affinity are described in section 5.4.3. In one embodiment of this combination, if the current event exhibits cache-affinity with regard to the last event, then the same destination used for the last event distribution is selected. The variable that stores the last event destination is used to choose the same destination as the last event. If the current event does not exhibit cache-affinity, the basic round-robin method can be used to select the destination.

5.4.2 Load Balancing Distribution Method

Referring now to FIG. 15B, in some embodiments, upon the discovery of events 1520, the event system consults load information 1522 and selects an event delivery destination based on this analysis 1524. In some of these embodiments, the system maintains load information with respect to each destination. Load information can consist of a single parameter such as the destination queue length, or it can be computed from multiple of parameters. One example of computed load information involves computations based on one or more parameters such as queue length, time elapsed since last dequeuing operation, communication cost to the destination non-uniform memory access processor, etc. The formula for computing the load can vary, ranging from such calculations as a simple approximation by destination queue length, to more complex multi-dimensional complex formula.

Examples of such formulas include:
L=Q, where L=Load and Q=Queue Length
if (processor core is on the same processor package and the communication cost is low)
Then L=Q
else L=C*Q, where L=Load, Q=Queue Length, and C=estimated communication cost across processor package (e.g. cross CPU-socket in a multi-CPU-socket machine or NUMA machine).

Another example of such a formula could look like the following:
L=T*Q*C, or L=T+Q*C
L=Load, Q=Queue Length, T=Time elapsed since last dequeue operation, C=estimated communication cost Communication cost would be different for different processors. For example C in the same processor package may be low, while C across processor packages may be high.

Any formula that consults parameters for load information may be used. The above are just examples of the many variations that an implementation can implement.

Referring now to FIG. 15B, in some embodiments, prior to distribution of an event or a group of events, the system retrieves and consults the load information 1522, selects a destination with relatively low load 1524 based on this information, and then directs the events to the selected destination 1526. The system may determine a destination as having a low load in a variety of ways, including, for example, having the lowest load or having a load below a predetermined threshold. The lowest load may not be the absolute lowest load, but may be an approximation or otherwise imprecise estimation. Additionally, multiple threshold levels can be used for determining the destination of distribution.

In some embodiments, a plurality of methods are used in combination, for example, combining a simple selection method or guess with more expensive methods such as selecting the lowest load destination. A first destinations selection is made, possibly at random. If the first selection is at or below a predetermined threshold level, then the first selection succeeds and is selected as the destination for delivery of the event. One or more of selection attempts can be made, for example, where a first selection did not produce a qualified destination. Different implementations can use different methods and thresholds to decide how many selection attempts of this type are made before determining the failure of these attempts and switching to another method. When it is decided that the attempts fail to produce a qualified destination, the system switches to using the lowest load estimate to select the destination. The system may use a variety of computations and algorithms to select the destination, including combination of randomized and non-randomized algorithms.

In some of these embodiments, the system generates runtime updates for the attributes used in calculations or formulae of load information, resulting in dynamic adjustment of, and therefore more accurate, load estimates. For example, after distributing one or more events 1526, the system updates attributes for the selected destination or destinations, where the attributes are used in load information determinations. In some embodiments, the system may update and compute destination load at predetermined intervals to reduce the cost of maintaining load information 1528.

Load balancing need not result in a complete and perfectly balanced load. Rather, the goal of load balancing can be selection of destinations with relatively low load, or attempting to avoid overloading high-load or highest load. For example, when some processors that are processing events have a relatively low load while other processors have been idle, the system may continue to direct events to the same processors, as long as the load on these same processors are relatively low, while leaving the idle processors idle. Such an implementation choice can provide improved cache-affinity behavior as a result of opting not to completely balance the load by directing events to the other idle processors. Such choices, after consulting load information, do not violate load balancing principles, and are an appropriate implementation in conjunction with other considerations such as efficiency of the system and implementation.

5.4.3 Cache-Affinity Distribution Method

In some embodiments, the event system directs events to the same destination as recent prior events that have the same or overlapping memory or cache memory access. In some embodiments, the event system maintains a memory access profile. The profile can be generated based on information from various sources. For example, the protocol and the file descriptor object of an event can readily be obtained from a network event by parsing headers of the packet. Such information would indicate at least some of the memory accessed during processing. Other memory access profile information can come from accessing the content of an event (e.g. packet payload message). Yet other memory access profile information may come from monitoring the memory access of executing programs. These are just some examples of memory access profile information sources. In some embodiments, one or more of these sources or methods are used to gather the memory access profile of past events and to estimate the memory access profile for incoming events. An implementation may use a wide variety of methods to gather such information.

In some embodiments, the event system maintains a memory access profile to distribution destination mapping. The number of mappings maintained can vary. In some embodiments, for example, an implementation may choose to maintain only a single mapping (e.g. the last mapping). In some embodiments, for example, an implementation may choose to maintain a table of multiple mappings. The table may be implemented using a variety of data structures, such as hash tables, lists, arrays, etc. The mapping information may also be embedded in other structures, for example, in file-descriptor objects, event queues, other queues, or other objects, and thus the table of mappings may not literally appear as a table in actual implementations, but can be various combinations of structures.

Referring now to FIG. 15C, in some embodiments, when an event arrives 1530, the event system selects the destination based on the estimated memory access profile of this event. The event system retrieves the stored mapping of existing memory access profiles to destinations 1531. The estimated memory access profile is compared to the stored mapping of existing memory access profiles 1532. If the incoming event's memory access profile exhibits similarity or overlap with one of the existing memory access profiles, the destination stored for the existing memory profile is selected as the destination for this incoming event 1533. The event system then distributes the event to the selected destination 1534.

In some embodiments, the cache-affinity distribution method is used in conjunction with other distribution methods. For example, when the incoming event's memory access profile does not match any stored existing memory access profile, the event system may choose some other method to select the destination for the event. In some embodiments, the cache-affinity method is used first to determine the distribution destination 1532. When it is determined that the incoming event does not exhibit cache-affinity with respect to any stored memory access profile, the incoming event is distributed using one or more different methods 1535, including the round-robin method as described in section 5.4.1 1536, consulting load information as described in section 5.4.2 1537, and random selection from a list of destinations 1538.

Referring now to FIG. 15D, in some embodiments, cache-affinity or flow-affinity are combined with the load information based distribution method as described previously. After selecting a destination based on cache-affinity 1540, 1541, 1542, the system determines if the destination's load is high (e.g. the load has exceeded a predetermined threshold) 1547. If the load is not high, the system distributes the event to the destination 1534. If the load is high, the system then selects a new destination 1546 based on consulting load information 1522 as described in section 5.4.2.

In some embodiments, the system updates the memory profile to destination mapping 1545 after event distribution. This occurs, for example, when an event memory profile did not exist in the stored mapping for a distributed event, or when a new destination is selected after consulting load information, Subsequently, the event system uses the updated mappings for future distribution decisions.

5.4.4 Flow-Affinity Distribution Method

Flow-affinity is concerned with distributing events belonging to a given traffic flow to the same processors or queues where recent prior events of that same traffic flow have been directed. In embodiments implementing a flow affinity method, the system maintains flow-to-destination mapping information. A flow can be identified using the header fields of the event. For example, in IP networking, a flow is identified by 5-tuples (protocol, source-address, source-port, destination-address, destination-port), or a subsets of these tuples.

Referring now to FIG. 15E, in some embodiments, for each arriving event 1530, the system retrieves flow-to-destination mapping information 1550. The system compares the incoming event's flow information to the stored flow information 1551. If the flow matches one of the existing flows, the destination stored for that existing flow is selected as the destination 1552. The event system then distributes the event to the selected destination 1534.

Cache-affinity of the flow states is one direct benefit resulting from flow-affinity methods. The mapping structures and determination methods used in cache-affinity distribution method embodiments can be applied to flow-affinity as well.

In some embodiments, the flow-affinity distribution method is used in conjunction with other distribution methods. For example, for the first event in a traffic flow (i.e. an event whose flow information does not match any of the stored existing flows), the event system may choose some other method to select the destination for this event 1535. In some embodiments, the flow-affinity method is used first to determine the distribution destination. If it is determined that the incoming event is the first event in a traffic flow, the incoming event is distributed using one or more different methods, including the round-robin method as described in section 5.4.1 1536, consulting load information as described in section 5.4.2 1537, or random selection from a list of destinations 1538.

Referring now to FIG. 15D, in some embodiments, flow-affinity or cache-affinity are combined with the load information based distribution method as described previously. In some embodiments, after selecting a destination based on flow affinity, the system determines if the destination's load is high (e.g. the load has exceeded a predetermined threshold) 1547. If the load is not high, the system distributes the event to the destination 1534. If the load is high, the system then selects a new destination 1546 based on consulting load information as described in 5.4.2 1522.

In some embodiments, after event distribution to a new destination that did not exist in the stored flow-to-destination map, for example, the first event in a traffic flow, or a new destination based on consulting load information, the system updates the flow's mapping to the new destination 1545, and subsequently uses the new event to destination mapping for future distribution decision.

5.5 Application-Defined Event Distribution and Event Filtering

In some embodiments, applications configure and supply distribution rules through system-provided API's. Such rules may include predicates that are evaluated by the system. The system interprets the rules or results of predicates to determine event destinations. In another embodiment, applications supply executable program logic through system provided API′a where such executable function is designed to indicate to the system which destination to select for a given event under some set of conditions. The system chooses the event destination based on the return value of such program logic execution.

Referring now to FIG. 15F, in one embodiment, for each event, the system consults one or more application-supplied rules or executable logical constructs 1560, selects the destination based on the application rules or output of the executable logic 1561, and directs the event to the selected destination 1534.

In some embodiments, the application supplied rules or executable logic may also be used as event filters where the supplied rules or executable logic determines whether an event is to be delivered (i.e. a filtering function as well as the destination-determining function).

Referring now to FIG. 15G and FIG. 15H, one or more application-supplied rules or executable logic are consulted before the arrival event is queued onto destinations 1573, or before application event handlers are invoked by the event system. In some embodiments, the result or output of application-supplied rules or executable logic is used to determine whether the event is to be delivered 1571, 1572. The application-supplied rule or executable logic may determine not to deliver an event, and thus the application-supplied rule or executable logic acts as filter 1572. Event delivery may take the form of, for example, enqueuing an event to a destination or directly invoking application event handlers. In one embodiment, the result or output of the application-supplied rule or executable logic may act as a Boolean decision output and provide no further guidance regarding the destination of distribution. In this case, the system will select the appropriate destination according to event system distribution methods, some of which for example are described in section 5.4.

In some embodiments, the application supplied rules or executable logic determines not only if an event is distributed, but also where to distribute the event 1675, 1676. When the result or output of the application-supplied rule or executable logic is to deliver the event, the result or output further provides selection information with respect to the destination or set of destinations 1675. In some embodiments, when the result or output indicates only one destination, the event is distributed to this destination. Such event distribution may follow the scaling distribution mode. In some embodiments, when the result or output indicates multiple destinations, the event is distributed to the multiple destinations. Such event distribution may follow the duplicate distribution mode where the same event is processed by multiple threads, each of which may implement a different application algorithm of event processing.

In some embodiments, The result or output of application-supplied rules or executable logic can also direct whether a direct invocation of an application event handler should occur, potentially also identifying which event handler should be invoked. The event system will deliver the event or invoke the event handler as instructed.

In some embodiments, application-supplied rules or executable logic for distribution and filtering may determine the distribution destinations, and no other distribution methods are needed. In some embodiments, user-defined rules or logic for distribution and filter may be implemented and used in conjunction with one or more other distribution methods such as those described in section 5.4.

In some embodiments, application-supplied rules or executable logic for distribution and filtering can be evaluated before or after packet demultiplexing. Application-supplied rules or logic may be provided raw events, or alternatively, higher-level information such as sockets, file descriptors, or event payload without lower-level protocol headers, and any combination thereof. Application-supplied rules or executable logic may be applied in isolation, or be combined to form connected graphs of logical predicates.

5.6 Event Distribution Mechanisms Applicable to Fast I/O and Traditional Operating System Event Systems

The configuration of event distribution described in section 5.2 may be implemented in conjunction with fast I/O event systems as described in section 5.1, or with a traditional event system. When configuration facilities described in section 5.2 are provided in explicit form in conjunction with traditional event systems, such combinations can add enhanced application control to these traditional systems.

Any combination of methods of distribution described in section 5.4 and event filtering described in section 5.5 may be implemented in conjunction with fast I/O event systems as described in section 5.1, or with a traditional event systems. These facilities, which were not available in traditional event system, can add multiprocessing ability to applications.

6.0 Event Directing and Task Queuing By Application Event Handlers

In some embodiments implementing an event-driven model, application event handlers enqueue events and tasks to one or more target processors or queues, thus effecting scheduling, directing further processing of events or both. The event handler execution and event-driven methods described previously in section 2 are incorporated here by reference. The event queuing API's may be separately provided by the system as described above in section 4. Task queuing may also be separately provided by the system as described below in this section. These API's and supporting structures are made accessible to application event handlers in their execution context. This system combination of event-driven methods with event queueing capabilities, task queuing capabilities or both provides application event handler with the ability to direct further event processing or task execution. Such capability can be used, for example, by a low-latency event handler that is thin and efficient while directing more complex processing to other processors, including multiple processors for parallel processing. Such ability can also be used to integrate incoming events into the computation streams on the target processors of event queuing, task queuing or both.

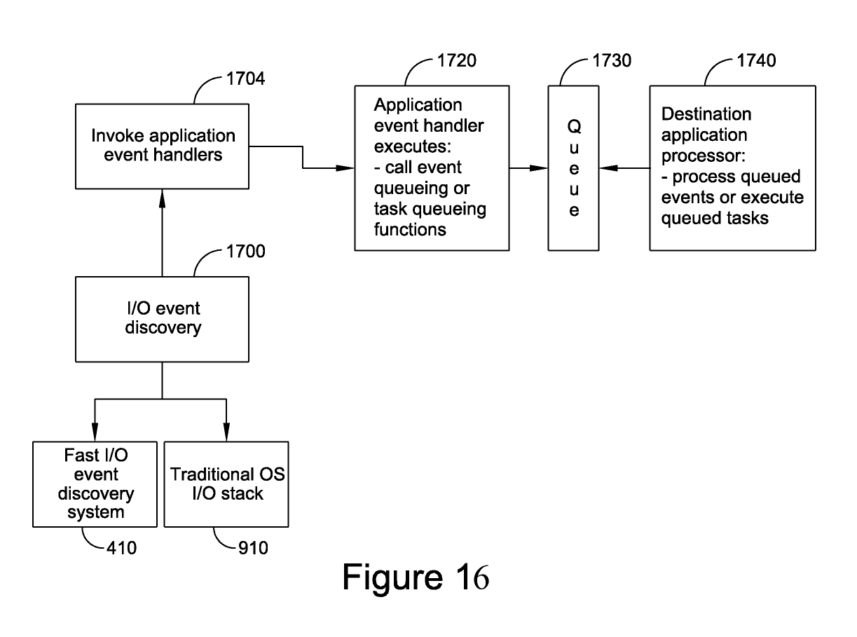

Referencing now FIG. 16, application event handlers further direct the processing of events, the scheduling of tasks or both. A generic event-driven system where application event handlers are invoked by the I/O event system can be implemented in conjunction with fast I/O and event discovery mechanisms 410, or with a traditional operating system I/O stack 910. There can be various ways of implementing event handler invocation after I/O event discovery 1700. For example, application event handlers may be invoked after the queuing of events to the application, to a system destination, or to both. Alternatively, they can be directly invoked after event discovery 1704. Such event-driven mechanisms and embodiments are described in preceding sections and incorporated herein by reference. These embodiments can be implemented in conjunction with the additional element of an event enqueue mechanism, a task enqueue mechanism or both where such element is made available to application event handlers.

During the execution of application event handlers, such handlers call system-provided functions for queuing events, tasks or both 1720, thus further directing event processing, task scheduling or both. The application-queued events and tasks are enqueued onto one or more queues 1730. The destination processors or threads 1740 may, for example, be application logic processors. In such embodiments, applications are directing further event processing or task computation from their event handlers, effectively integrating sporadic events into application computation. At the destination, there are a variety of methods available to applications to process these queued events. For example, an application may choose to use an event-driven approach where system-supplied polling threads at the destination processor poll the queue 1730 and invoke another level of application event handler at the same destination processor. As another example, an application may choose to poll the event queue itself and process the event after dequeuing it from the event queue 1730. In yet another example, tasks that are enqueued are executed on the destination processor.

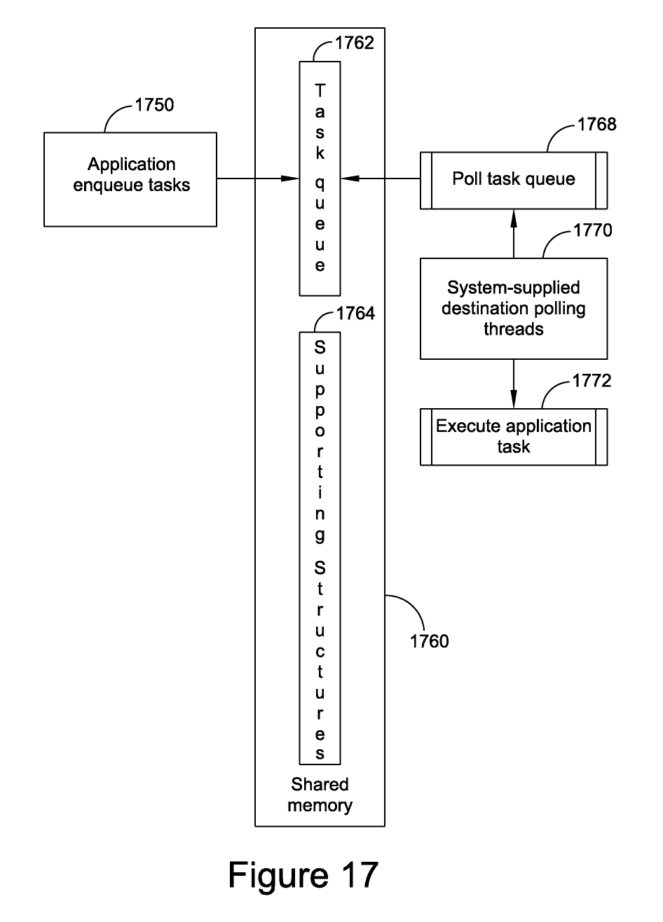

In some embodiments, event queuing functionality is provided by the system as described above in section 4. In some of these embodiments, the system provides task queuing without interrupt or context switching. Referring now to FIG. 17, shared memory 1760 is mapped into both the enqueueing application or system address-space and the destination address-space. The shared memory region mapped includes the task queue 1762, and may include some or all supporting structures 1764 for the enqueuing and dequeuing of tasks. In one embodiment, supporting structures include task objects that are to be enqueued and allocated from the shared memory space. Both the enqueuing space and the destination have direct access to the task queue 1762 using shared memory 1760. In one embodiment, at the destination, there is a system-supplied destination polling thread 1770 that polls 1768 on the task queue 1762, and upon dequeuing and retrieval of the task, the task is executed or scheduled for execution 1772. Thus, both task enqueuing, and task retrieval from the destination, occur without context switching. This is referred to as light-weight task queuing.

In some embodiments, event queuing, light-weight task queuing functionality, or both are provided by the system and made available to the application event handlers in their execution environment. For example, when an application event handler executes in user-space by any of the methods of the event-driven systems described in section 2, the application event handler has access to the libraries made available to the application or system programs in user-space. These can include, for example, the event queuing functionality, the light-weight task queuing functionality or both. When an application event handler executes in kernel-space, the event queuing and light-weight task queuing functionality are accessible, for example, through libraries that can be linked to application code running in kernel-space. Message queues can be provided by the system, and implemented similarly using shared memory accessible to both enqueueing application event handlers and the destination processor, thus allowing enqueue and dequeue operations without context switching. Message queues can thus be used in lieu of event queues in embodiments described in this section.

7. Multicast API

In some embodiments, applications invoke multicast API's to send or write one or more of the same messages to multiple destinations in a single call. One example of a multicast API in some embodiments includes a send call prototyped as follows:

sendm(sockets_to_send_to, message, message_size, . . . );

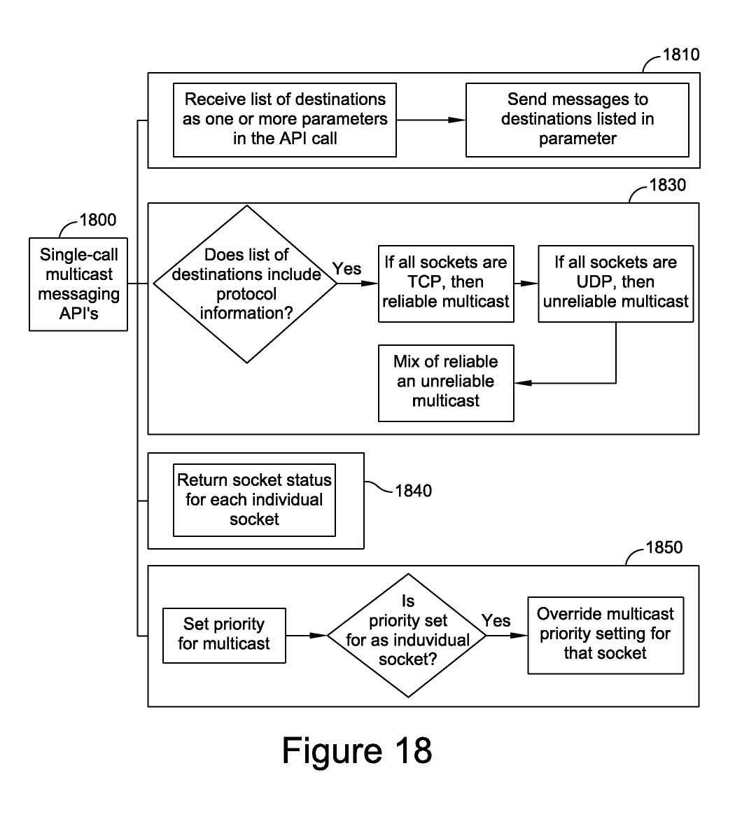

Referring now to FIG. 18, an application calls sendm( ), passing it argument values such as the sockets or file descriptors where the message is to be sent, the pointer to the message, the size of the message, etc. The same message is then sent to all destinations represented by the list of sockets or file-descriptors in the argument 1810. The list of destinations specified by the sockets_to_send_to parameter can be provided in any form, including such forms as an array, list, hash table, etc. Sockets can be provided in any form, including as an opaque handle, file descriptor or other indirect reference. The list of destinations can be specified by means other than sockets as well. For example, a list of destination addresses such as IP addresses can be specified.

In some embodiments, multiple messages are sent to multiple destinations in a single call 1800. One example of a multicast API of this type includes a send call prototyped as follows:

sendm(sockets_to_send_to, list_of_messages, . . . )

An application calls sendm( ), passing it argument values such as the sockets or file descriptors where the message is to be sent and a list of messages. The same set of messages defined by this list of messages is sent to all destinations represented by the list of sockets or file descriptors in the sockets_to_send_to argument. This is in contrast to the lio_listio API, which is a list of separate I/O operations, where each message is sent to the corresponding file descriptor and different messages are sent to each different file descriptor. In these list embodiments of the multicast API, the same list of messages is sent to each of the different socket in the list of sockets.

In some embodiments, there is no need for the application to configure or otherwise create a multicast group prior to calling the multicast API 1810. A list of destination sockets is provided in the send call itself. In a single call where a list of destinations is given, the message is sent to all destinations in the list of sockets. In contrast, conventional multicasting API's generally required an application to create a multicast group prior to, and separately from, the send calls. Multicast groups were created first, and then returned a handle or file-descriptor for the multicast group. Alternatively, with conventional multicast, a multicast group was formed in the network with its own multicast address, and a socket was opened to represent the network multicast group to the application. Membership was then added to the multicast group. Applications subsequently sent messages to the socket or handle that represented the previously formed multicast group.

In some embodiments, the system uses the list of sockets_to_send_to parameter to support both reliable and unreliable multicasting 1830. For example, if the list of sockets provided are in the nature of a set of unreliable connections, such as UDP sockets or other unreliable protocol sockets, then the multicast is unreliable. Alternatively, if the list of sockets provided are in the nature of a set of reliable connections, such as TCP sockets or other reliable protocol sockets, then the multicast is reliable. The individual socket type and its protocol specify the reliability aspect of the multicast. For example, TCP sockets would indicate the reliability that the multicast should be ordered delivery with acknowledgments. Other types of protocols that are available for individual sockets can be used by applications with multicast send( ). Examples include various ordered and reliable protocols, request-response style, and reliable but not necessarily ordered.

In some embodiments, the system has a separate multicast version implementing a reliable protocol from that defined for individual connections. In other embodiments, the event system has substantially the same implementations as the reliable protocol used for individual connections. The system can restrict the set of reliable protocols available in a set of multicast send API's. For example, all sockets in the list of sockets must be of the same protocol. For unreliable multicast, all sockets in the list must be UDP sockets. For reliable multicast all sockets in the list must be TCP sockets. In some embodiments, an application specifies a mix of protocols for the list of sockets provided in the multicast send call. For example, a mix of UDP protocol sockets and TCP protocol sockets are provided by the application, in which case, some destinations of the multicast need not be reliable, while other destinations are reliable. Thus, the same multicast API can be used for unreliable or reliable multicast, as the reliability is specified by the sockets' protocol.

In some embodiments, return values for the status for each individual socket in the list of sockets passed to the send call are provided 1840. Additionally, priority can be specified for the entire multicast, for individual sockets, or for a combination of both, where the priority set for an individual socket overrides the priority set for the entire multicast with respect to that individual socket 1850. Zero or more parameters in addition to the example or described parameters may be given. Return values can also vary widely depending on implementation. Parameters given need not be a list of parameters, but can take other forms, such as members in a structure, and any combination thereof.

Although networking I/O examples are used in this section, similarly-structured multicast API's and capabilities can be readily constructed for other types of I/O where the same content can be written to multiple destinations in a single call. These other types of I/O include, for example, storage I/O and file I/O.

In some embodiments, the multicast send API's are implemented for use in a multiprocessing environment. For example, multiple application thread, processors or both use the multicast send API's to send messages to multiple destinations concurrently. The set of sockets to destinations in different multicast send calls in different threads may overlap.

8. Methods and Systems for Fast Task Execution and Distribution Using Hardware Inter-processor Communication Mechanisms

Modern processor architectures offer platform-level support for inter-processor communication (“IPC”), ranging from inter-processor interrupt (“IPI”) to sophisticated facilities such as register interfaces for direct access to on-chip interconnect network. Some of the hardware IPC facilities are capable of unicast (i.e. one processor to another), multicast (i.e. one processor to several), and broadcast (i.e. one processor to all others). The system may choose to use one or more of these facilities.

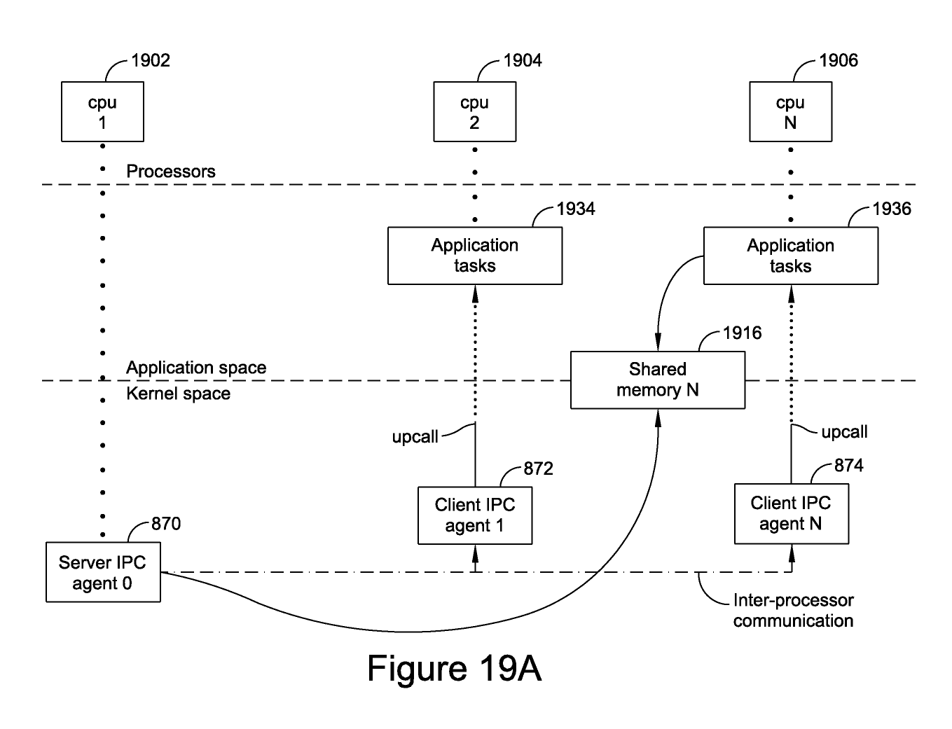

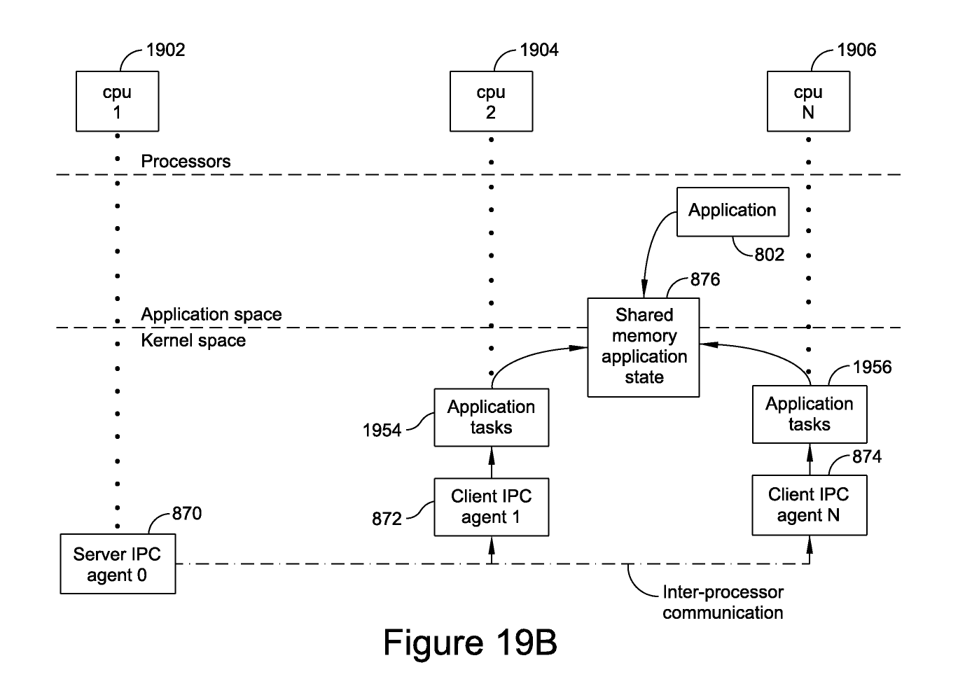

Referring now to FIG. 19A, in one embodiment, the system provides a server IPC agent software module 870 executing on a processor 1902 in kernel-space. The server IPC agent 870 initiates fast task distribution using hardware IPC mechanisms. The Client IPC Agent software module 872, 874 processes IPC requests.

In one embodiment, IPI is the underlying hardware IPC mechanism. Client IPC agents 872, 874 are IPI interrupt handlers. The system may use different IPI vectors from what the operating system kernel uses, avoiding unnecessary crosstalk with operating system IPI traffic. In another embodiment, MONITOR/MWAIT hardware primitives are used. MONITOR/MWAIT was an addition to the x86 architecture families, and available at ring 0. In this embodiment, inter-processor communication is initiated by a memory write to a memory range that is shared between two processors. The system may use one or more hardware IPC mechanisms provided by the underlying hardware.

Referring to FIG. 19A, in a first embodiment, to distribute a task, for example from one processor 1902 to another processor 1904, the server IPC agent 870 first initiates an IPC request using any of the hardware IPC mechanisms. In one embodiment, the hardware IPC mechanism used is a unicast IPI request to a processor 1904. In another embodiment, the hardware IPC mechanism is a multicast IPI request to a group of processors. Upon receiving the IPI, the processor 1904 invokes the client IPC agent 872. The client IPC agent 872 then issues an upcall to the application task 1934. Kernel to user-space upcall is used to execute the task or other executable program equivalents, such as event handlers. As a result of the upcall, the application task 1934 executes on the processor 1904. In this embodiment, task parameters are passed to user-space using the upcall stack.

In a second embodiment, to distribute a task, for example, from one processor 1902 to another processor 1906, the server IPC agent 870 distributes tasks by first writing the task parameters to a pre-configured shared memory area 1916. The shared memory area 1916 is mapped into both kernel-space and application-space, and is therefore accessible by both the server IPC agent 870 and the application task 1936. The server IPC agent 870 then initiates an IPC request using any of the hardware IPC mechanisms. Next, the processor 1906 invokes the client IPC agent 874, which then retrieves and analyzes configuration information and issues an upcall to the application task 1936. The application task can be a task or other executable program equivalent such as an event handler. As a result of the upcall, the application task 1936 executes on the processor 1906. Using shared memory to pass large-sized task parameters to user-space results in improved efficiency. The efficiency partly derives from the avoidance of extra memory copying operations.

Referring now to FIG. 19B, in a third embodiment, to distribute a task, for example from one processor 1902 to another processor 1904, the server IPC agent 870 first initiates an IPC request using any of the hardware IPC mechanisms. In this embodiment, the application tasks 1954, 1956 execute in kernel-space. The application task can be a task or other executable program equivalent such as an event handler. A shared memory area 876 is pre-configured, and application states that need to be accessed by the application tasks 1954, 1956 are mapped into kernel-space. Upon receiving the IPC request, the processor 1904 invokes the client IPC agent 872, which in turn invokes the application task 1954. As a result, the application task processes the task, while having access both to the task parameters and relevant application state. The system may provide compilation, linking facilities or both to make application tasks executable or callable in kernel-space.

Any processor can execute the server IPC agent 870, the client IPC agent 872, 874 or both. The application or the system may elect to operate the processors in fully symmetric mode, or elect to partition the processors into separate server and client processor groups.

In some embodiments, the system provides generic task handlers. Application tasks and parameters for these tasks are packaged as task objects. Instead of directly invoking application tasks, the system invokes the generic task handler, which in turn executes the application tasks. This mode of operation allows code-sharing with a minor reduction in speed.

Although the embodiments described in FIG. 19A and FIG. 19B shows the server IPC agents 870 and client IPC agents 872, 874 residing in kernel-space, such residency is not required. On available architectures, hardware IPC mechanisms were accessible only to programs executing at ring 0. In the future, if new hardware mechanisms accessible to user-mode programs become available, the server IPC agents 870 and client IPC agents 872, 874 can reside in application-space. If the server IPC agents 870 and client IPC agents 872, 874 reside in user-space, kernel-to-user upcalls and shared-memory mappings may be eliminated altogether, and invocation of application tasks can consist of only a function call.

There are numerous advantages resulting from the system and methods of task distribution disclosed herein. First, distributing and executing tasks using hardware IPC mechanisms are far more efficient than using operating system process or thread scheduling facilities. Second, application tasks have full access to application states because they either execute in application address-space, or because they have access through shared memory. This contrasts with conventional systems where such tasks have to execute in kernel-space and have no access to application states. Finally, the client processors wake up on demand and do not need to operate in polling mode. This is more energy efficient.

In some embodiments, the system provides facilities for configurations, and facilities for receiving tasks. In some embodiments, configuration facilities provide information such as target IPI vectors (if IPI is used for IPC), processor groups for multicast requests, memory regions and address space information for application tasks information necessary for creating shared memory mapping, etc.

The system provides multiple mechanisms for receiving tasks. In some embodiments, applications are a source of tasks. For example, application tasks can be statically or dynamically linked into the system. In another example, shared memory may be used, where applications enqueue task objects from user-space, and server IPC agents 870 dequeue the tasks from kernel space. In other embodiments, the kernel can be source of tasks. I/O and event systems, which may execute in kernel-space or user-space, can be the source of tasks. For example, I/O and event system may package I/O events as task parameters and invoke application event handlers as tasks in some embodiments of this system.

The following is an alphabetically sorted glossary of terms used in this patent application:

| Term | Definition |
|---|---|
| Active Polling | A polling method that includes at least one dedicated system |
| | polling thread that continuously polls for I/O events. |
| AIO | See “Asynchronous I/O.” |
| API | See “Application Programming Interface.” |
| Application Event | Program code or routines supplied by an application and called |
| Handler | by the system upon arrival of events. The events may be I/O |
| | events, inter-processor, inter-thread or inter-process |
| | communications. |
| Application | A specification used as an interface by software components to |
| Programming Interface | communicate with each other, and may include specifications |
| | for routines, data structures, object classes, and variables. |
| Application-Space | Application-space is the address space of an application |
| | process. |
| Asynchronous I/O | A form of input/output processing that permits an application |
| | thread to continue doing other work or processing rather than |
| | block application processing while waiting for the I/O |
| | operation to complete. More specifically, this involves first |
| | posting of an I/O operation by an application and then polling |
| | for completion. AIO semantics generally require prior posting |
| | of I/O operations before events such as completion can be |
| | delivered. |
| Completion Queue | In asynchronous I/O, a queue containing information about |
| | completed I/O operations previously posted. When the prior |
| | posted I/O operation completes, the system usually stores the |
| | completion information in a queue. Such structures are usually |
| | referred to as completion queues. An application can poll the |
| | completion queue to determine if its posted I/O operation has |
| | completed. |
| Context Switching | Storing and restoring the state of a CPU so that execution can |
| | be resumed from the same point at a later time. This includes |
| | activities involving the switching of threads or processes. This |
| | may also include transitions between kernel-mode and user- |
| | mode, and in general, switching to and from different address |
| | spaces by an OS kernel. |
| Conventional AIO | See “Asynchronous I/O.” |
| System | |
| Conventional Operating | Conventional operating systems include an I/O system that sits |
| System | above the conventional I/O stack that uses interrupt-based |
| | methods involving context switching, and an event system that |
| | is integrated with the conventional I/O stack. Examples |
| | include Unix (including Linux) and Windows. |
| Core | A microprocessor inside of a central processing unit. |
| Dequeue | Any method that removes an object or event from a queue. |
| Destination | A processor, thread, or queue, or a set of processors, threads, or |
| | queues, where events are delivered. |
| Direct Accessing of I/O | The accessing of an I/O device through a device driver without |
| Device | intervention by additional layers or interfaces (e.g. operating |
| | system kernel). |
| Direct Accessing of | Accessing memory without context switching and without |
| Memory | intervention by external system services (e.g. operating system |
| | kernel). Memory that can be directly accessed is either in the |
| | process' address space or is being mapped into a memory space |
| | accessible to that process. |
| Event | I/O events, inter-processor, inter-thread, or inter-process |
| | communications. See “I/O Events.” |
| Event-Driven Model | An Event System model for processing events where event |
| | handlers are supplied by the application and are called by the |
| | system rather than applications engaging in continuous polling. |
| Event Handler | Methods or software modules that process events and are called |
| | by the system. This can include application event handlers |
| | supplied by an application. |
| Event-Polling Model | An Event System model of processing events where |
| | applications poll for events, generally in event processing loops |
| | directed by the application to continuously poll events queues. |
| Event Queue | A queue enabled to take delivery of events, including I/O |
| | events or equivalents of events such as tasks or other objects, |
| | from multiple file descriptors. Event queues and equivalents |
| | are described in more detail in section 3 and included here by |
| | reference. |
| Fast I/O Event | Systems that utilize fast I/O event discovery mechanisms as the |
| Discovery System | primary event discovery method. Fast I/O event discovery |
| | mechanisms are described in detail in section 1 and included |
| | here by reference. |
| Fast I/O System | I/O events are primarily discovered through polling. This is in |
| | contrast to conventional I/O systems that use interrupts as the |
| | primary I/O event discovery mechanism and soft IRQs or |
| | deferred procedures for subsequent processing. Event |
| | discovery mechanisms in conjunctions with fast I/O are |
| | described in detail in section 1 and included here by reference. |
| File Descriptor | An abstract indicator (e.g. a number or a handle) that represents |
| | access to a file or to I/O. A File Descriptor can represent a file |
| | or I/O access. For example, a File Descriptor of a socket (i.e. |
| | socket descriptor) represents access to a network. Similarly, a |
| | File Descriptor can represent access to a block device such as |
| | disk. A file descriptor table is not required. Any opaque or |
| | indirect reference to objects that represent access to a file or |
| | I/O can be called a File Descriptor. |
| File Handle | See “File Descriptor.” |
| I/O Events | Events coming from I/O sources. The arrival of packets from a |
| | network, and disk access completion are examples of I/O |
| | Events. Examples of I/O sources include networks and storage, |
| | including disks and network-attached storage. |
| Inter-process | A set of methods for the exchange of data/messages among |
| Communication | multiple threads or processors in one or more processes, |
| | both of which can be inside same process address space or in |
| | different process address space. This is in contrast to |
| | traditional IPC that is defined as communication across |
| | different process and usually different address spaces. |
| Inter-processor | See “Inter-process Communication.” |
| Communication | |
| IPC | See “Inter-process Communication.” |
| Kernel-Mode | Execution inside the operating system kernel that has the |
| | privilege to execute any instructions and reference any memory |
| | addresses. |
| Kernel-Space | Memory space that can only be accessed by privileged |
| | programs (e.g. the kernel, kernel extensions, and device drivers |
| | in kernel mode). |
| Light-Weight Task | Task enqueuing and dequeuing without context switching. |
| Queuing | Light-weight task enqueuing and dequeuing are described in |
| | detail in section 6 and included here by reference. |
| Memory Mapping | Taking a segment of memory which otherwise does not belong |
| | to, or is not accessible from, a process P1 address space, and |
| | using virtual memory techniques to present this segment of |
| | memory to process P1 as if it was in P1 address space. This |
| | enables P1 to directly access this memory segment without |
| | context switching. The only time the kernel is involved is |
| | when the mapping call itself is invoked (e.g. on UNIX/Linux |
| | mmap( ) call). |
| Multicasting | Sending the same message or pay-load to multiple destinations |
| | in a single I/O operation. |
| NIC | A network interface controller, also commonly known as a |
| | network card, or network adapter. |
| Opaque Handle | An indirect reference to a system object (e.g. socket object). |
| | See also “File Descriptor.” This is in contrast to a direct |
| | memory pointer or otherwise direct reference to an underlying |
| | system object. |
| OS Bypassing | I/O operations that bypass or work on separate paths from the |
| | host operating system kernel I/O stack. |
| Passive Polling | Polling that occurs when the application issues one of the I/O |
| | or event system operations that cause the system to poll for an |
| | I/O event. |
| Polling | Active sampling of the status of an I/O device or queue. When |
| | polling is referred to as a method of sampling and discovery of |
| | I/O events, it is in contrast to interrupt driven I/O event |
| | discovery as employed by traditional operating system in |
| | traditional operating system I/O stacks. |
| Polling Entity | A thread, processor, set of threads or set of processors that poll |
| | for I/O events or poll a queue. |
| Post and Completion | Posting asynchronous I/O operations and later polling for |
| Model | completion status of the posted I/O operation. See also above |
| | “Asynchronous I/O.” |
| Process | A protection domain that can contain multiple threads |
| Processor | See “Core.” |
| Queue | Queues refer to any interface through which two or more |
| | parties can communicate. They may be queues in the |
| | traditional sense, structures, a complex set of interfaces with |
| | multiple interface elements, or associated interface methods. |
| | The implementation of queues can vary widely. For example, |
| | queues can be implemented as data structures, including |
| | structures such as conventional queues, ring buffers, arrays, |
| | lists, hash tables, maps, tables, stacks, etc. They need not be a |
| | single data structure, but can be a set of replicated structures, |
| | processor-specific structures, multiple types of structures, or |
| | any combinations thereof. Order of access does not matter. |
| | Concurrency, such as that implemented with concurrent queues |
| | or other concurrent data structures, as well as other features |
| | such as searching, iterating/enumerating, querying, filtering, |
| | etc. can be added to base data structure implementations, |
| | implementations of the queuing interfaces, or implementations |
| | of the system. |
| Shared Memory | Memory segment that can be accessed from two or more |
| | different address spaces. The access to shared memory is |
| | without context switching or kernel involvement once memory |
| | mapping is complete. |
| Socket | An I/O object that represents access to a network from an |
| | application context. |
| System Space | The address space where the system executes. This space can |
| | be a different address-space from the application address-space |
| | where the application executes. “System” may include I/O and |
| | the event system, as well as other system services. System- |
| | space can be in either the user-space, the kernel space, or both |
| | depending on how the system program segments are structured. |
| | In user-space, the system can execute in the same address space |
| | as the user application program. In this case there is no |
| | distinction between application address-space and system- |
| | space. In user-space, the system can also execute in a different |
| | process and address-space from the user application process, in |
| | which case system-space is in a different address-space from |
| | application address-space. In kernel-space, the system is |
| | generally in a different address-space from the user application |
| | address-space. Kernel-space is generally privileged. |
| Task | Code or program that is a unit of execution. |
| Task Queue | Queue that stores tasks, usually for scheduling of execution. |
| TCP | See “Transmission Control Protocol.” |
| Thread | The smallest unit of processing that can be scheduled by an |
| | operating system kernel. Multiple threads can exist within the |
| | same process. |
| Transmission Control | A transmission protocol that provides reliable, ordered delivery |
| Protocol | of a stream of bytes from a program on one computer to |
| | another program on another computer. See RFC 793 TCP |
| | specification. |
| UDP | See “User Datagram Protocol” |
| Upcall | Kernel functionality that allows a kernel module to invoke a |
| | function in user-space |
| User Datagram Protocol | A stateless transmission protocol that provides unreliable, |
| | delivery of datagrams from a program on one computer to |
| | another program on another computer. See RFC 768 UDP |
| | specification. |
| User-Mode | A process running in a private virtual address space without |
| | privilege to access other memory locations. |
| User-Space | Any non-privileged process or address-space in which a user |
| | processes run. |
| VI | See “Virtual Interface.” |
| Virtual Interface | Virtual Interface is the interface between a NIC that |
| | implements Virtual Interface Architecture or similar |
| | specification or design and a process that allows the NIC direct |
| | access to the process' memory. A VI usually contains at least a |
| | pair of Work Queues - one for send operations and one for |
| | receive operations. The work queues usually store the |
| | application posted I/O operations. When the posted I/O |
| | operation is completed, the completion info is usually stored in |
| | a completion queue where the user-space program can poll for |
| | completion status. Thus, the way VI works is similar to an |
| | asynchronous I/O post-and-completion model. |

In light of the exemplary embodiment and multiple additions and variations described above, the scope of the present invention shall be determined by the following claims.

We claim:

1. A computer event handling process comprising:
a) a computer operating system running one or more active input/output polling threads;
b) the one or more active input/output polling threads continuously actively polling for input/output events from one or more input/output devices; and
c) upon discovery of a first input/output event from a first input/output device, a first active input/output polling thread among the one or more active input/output polling threads invoking an application event handler for an application.

2. The computer event handling process of claim 1 wherein the one or more active input/output polling threads run on one more dedicated processors.

3. The computer event handling process of claim 2 wherein, during the invoking step (c), providing to said application a descriptor of an input/output object associated with the first input/output event.

4. The computer event handling process of claim 2 wherein, during the invoking step (c), an application-specified object associated with the first input/output event is provided to said application.

5. The computer event handling process of claim 1 wherein, prior to the invoking step (c), the computer operating system completes immediately preceding TCP and IP protocol processing.

6. The computer event handling process of claim 1 wherein, prior to the invoking step (c), the computer operating system completes immediately preceding UDP and IP protocol processing.

7. The computer event handling process of claim 1 wherein the one or more active input/output polling threads continuously actively poll for input/output events through one or more virtual interfaces.

8. The computer event handling process of claim 1 wherein the one or more active input/output polling threads continuously actively poll for input/output events through one or more one or more device drivers providing access to one or more input/output devices.

9. A computer event handling process comprising:
a) a computer operating system executing in parallel a plurality of active input/output polling threads, each of said active input/output polling threads continuously actively polling for input/output events from among a plurality of input/output devices;
b) upon discovery of a first input/output event, a first active input/output polling thread among the plurality of active input/output polling threads invoking a first application event handler for a first application; and
c) upon discovery of a second input/output event, a second active input/output polling thread among the plurality of active input/output polling threads invoking a second application event handler.

10. The computer event handling process of claim 9 wherein each among the plurality of active input/output polling threads executes on a polling-thread-dedicated processor.

11. The computer event handling process of claim 9 wherein, during the invoking step (c), providing to said first application a descriptor of an input/output object associated with the first input/output event.

12. The computer event handling process of claim 9 wherein, during the invoking step (c), providing to said first application an application-specified object associated with the first input/output event.

13. The computer event handling process of claim 1 wherein, prior to the invoking step (c), the computer operating system completes immediately preceding (i) IP and (ii) TCP or UDP protocol processing.

14. A computer event handling process comprising:
a) executing, with a computer operating system, one or more active input/output polling threads, each among the one or more active input/output polling threads polling for input/output events from among one or more input/output devices and, upon discovery of an input/output event, enqueing the input/output event onto one or more input/output event queues; and
b) while executing, with the computer operating system, one or more input/output event queue polling threads on the one or more input/output event queues, dequeuing of a first input/output event from the one or more input/output event queues and invoking one or more application event handlers with the one or more input/output event queue polling threads.

15. The computer event handling process of claim 14 wherein each among the one or more input/output polling threads executes on a thread-dedicated-processor.

16. The computer event handling process of claim 14 wherein each among the one or more input/output polling threads is distinct from the one or more input/output event queue polling threads.

17. The computer event handling process of claim 16 wherein each of the one or more input/output polling threads execute on one or more dedicated input/output polling thread processors and each of the one or more input/output event queue polling threads execute on one or more dedicated input/output event queue polling processors.

18. The computer event handling process of claim 14 wherein a first plurality of input/output events associated with a first plurality of multiple file descriptors are enqueued to the first or another event queue, and a second plurality of input/output events associated with multiple file descriptors are enqueued to the second or a third event queue.

19. The computer event handling process of claim 18 wherein a first plurality of input/output events associated with a first plurality of multiple sockets are enqueued to the first or another event queue, and a second plurality of input/output events associated with a second plurality of multiple sockets are enqueued to the second or a third event queue.

20. The computer event handling process of claim 14 wherein each among the one or more active input/output polling threads actively poll continuously during operation of the operating system for input/output events through one or more virtual interfaces.

21. The computer event handling process of claim 14 wherein each among the one or more input/output polling threads actively poll continuously during operation of the operation of the operating system for input/output events through one or more device drivers providing access to one or more input/output devices.

22. A computer event handling process comprising:
a) executing in parallel, with a computer operating system, a plurality of active input/output polling threads, each among the plurality of active input/output polling threads polling for input/output events from among a plurality of input/output devices and, upon discovery of each input/output event among a plurality of input/output events, enqueing each input/output event onto one or more input/output event queues among a plurality of input/output event queues; and
b) while executing in parallel, with the computer operating system, a plurality of input/output event queue polling threads with a first input/output event queue polling thread polling on a first input/output event queue among the plurality of input/output event queues and a second input/output event queue polling thread polling on a second input/output event queue among the plurality of input/output event queues:
i) dequeuing of a first input/output event from the first input/output event queue and invoking a first application event handler with a first input/output event queue polling thread among the plurality of input/output event queue polling threads; and
ii) dequeuing of a second input/output event from the second input/output event queue and invoking a second application event handler with a second input/ouput event queue polling thread among the plurality of input/output event queue polling threads.

23. The computer event handling system of claim 22 wherein each among the plurality of active input/output polling threads executes on a dedicated processor and multiple active input/output polling threads execute concurrently in parallel on multiple dedicated processors.

23. The computer event handling system of claim 21 wherein the plurality of active input/output polling threads are distinct from the input/output event queue polling threads.

24. The computer event handling system of claim 22 wherein the plurality of active input/output polling threads execute on a first set of processors and the plurality of input/output event queue polling threads execute on a second set of processors not including any processors among the first set of processors.

25. A computer event handling system comprising:
a) event polling, with a computer operating system, for input/output events from among one or more input/output devices;
b) upon discovery of one or more input/output events through said event polling, enqueing the one or more input/output events to one or more input/output event queues and enqueuing a plurality of input/output events with multiple descriptors to the one or more input/output event queue; and
c) application polling for a plurality of input/output events through an event polling application programming interface.

26. The computer event handling system of claim 25 wherein the event polling application programming interface causes event queue polling the said one or more input/output event queues and dequeuing from one input/output event queue the or another plurality of input/output events associated with the or differing multiple descriptors.

27. The computer event handling system of claim 26 wherein the number of file descriptors is a greater than a multiple of the number the one or more input/output event queues.

28. The computer event handling system of claim 26 wherein all the input/output events associated with the or differing multiple descriptors are enqueued to the one input/output event queue or destinations associated with the one input/output event queue.

29. The computer event handling system of claim 26 wherein the event polling is continuously active polling by one or more active input/output polling threads supplied by the computer operating system.

30. The computer event handling system of claim 26 wherein the event polling includes passive polling by the computer operating system in response to an application calling an application programming interface supplied by the computer operating system.

31. The computer event handling system of claim 26 wherein the event polling includes polling through one or more virtual interfaces.

32. The computer event handling system of claim 26 wherein the event polling includes polling through one or more device drivers for the or another one or more input/output devices.

33. The computer event handling system of claim 29 wherein the one or more active input/output polling threads execute on one or more dedicated processors.

34. A computer event handling process comprising:
a) executing in parallel, with a computer operating system, a plurality of active input/output polling threads, with each among the plurality of active input/output polling threads continuously event polling for input/output events from one or more input/output devices and, upon discovery of each input/output event among a plurality of input/output events, enqueing each input/output event onto one or more input/output event queues among a plurality of input/output event queues, including enqueuing a set of input/output events associated with multiple descriptors to one input/output event queue; and
b) application polling for a plurality of input/output events through an event polling application programming interface supplied by the computer operating system.

35. The computer event handling system of claim 34 wherein the event polling application programming interface causes event queue polling the said one or more input/output event queues and dequeuing from the one input/output event queue the set of input/output events associated with multiple descriptors.

36. The computer event handling system of claim 35 wherein the number of file descriptors is greater than a multiple of the number the one or more input/output event queues.

37. The computer event handling system of claim 35 wherein the event polling includes polling through one or more virtual interfaces.

38. The computer event handling system of claim 35 wherein the event polling includes polling through device drivers communicable with input/output devices.

39. The computer event handling system of claim 35 wherein the plurality of active input/output polling threads execute on dedicated processors.
